(19) United States
(12) Patent Application Publication
(10) Pub. No.: US 2007/0158624 A1
(43) Pub. Date: Jul. 12, 2007

(54) Time-temperature indicators

(76) Inventors: Christoph Weder, Shaker Heights, OH (US); Maki Kinami, Shiga (JP); Brent Crenshaw, Cleveland Heights, OH (US)

Correspondence Address: HUDAK, SHUNK & FARINE, CO., L.P.A., 2020 FRONT STREET, SUITE 307, CUYAHOGA FALLS, OH, 44221, US

(21) Appl. No.: 11/651,343

(22) Filed: Jan. 9, 2007

Related U.S. Application Data
(60) Provisional application No. 60/758,106, filed on Jan. 11, 2006.

(51) Int. Cl. G02F 1/361

(52) U.S. Cl. 252/582; 524/205

(57) ABSTRACT

Time temperature indicators are disclosed which comprise at least one carrier material and one aggregachromic indicator dye and which respond to the combined effects of temperature and time with an easily measurable, time-temperature dependent, irreversible, color change. The invention also discloses to methods to produce such time-temperature indicators and materials therefore. Also, the devices disclose methods for determining the time/temperature history.

### CROSS REFERENCE

This application claims the benefit of priority under 35 U.S.C. § 119 of U.S. Provisional Application Ser. No. 60/758,106 filed on Jan. 11, 2006.

### STATEMENT OF GOVERNMENT INTEREST

This invention was made with support from the Government under National Science Foundation Contract No. DMI-0428208 through the Division of Design and Manufacturing Innovation. The Government has certain rights in the invention.

### FIELD OF THE INVENTION

The present invention relates to time-temperature indicators and in particular time-temperature indicators which comprise at least one carrier material and one aggregachromic indicator dye and which respond to the combined effects of temperature and time with an easily measurable, time-temperature dependent, irreversible, color change. The invention also relates to methods to produce such time-temperature indicators.

### BACKGROUND OF THE INVENTION

Time-temperature indicators (TTI), sometimes also referred to as time-temperature integrators, time-temperature monitors, or threshold temperature indicators, are devices that can be used to monitor the time/temperature history, for example of certain objects or places (Taoukis, P; Labuza, T. P; Food Technol. 1991, 45, 70-82. Taoukis, P; Labuza, T. P; Chemical time-temperature integrators as quality monitors in the chill chain; in Proceedings of the International Symposium Quimper Froid'97; Predictive Microbiology of chilled foods. Jun. 16-18, 1998. Wells, J. H.; The application of time-temperature indicator technology to food quality monitoring and perishable inventory management; in Mathematical Modelling of Food Processing Operations; Thorne, S., Ed.; Elsevier: London 1998, 271-344. Selman, J. D.; Time-temperature indicators; in Active Food Packaging; Rooney, M. L. et al.; Eds.; Blackie Academic and Professional, London: 1995, 215-237. ASTM F1416-96; Standard Guide for Selection of Time-Temperature Indicators, 2003). It is well known in the art that various embodiments of TTIs are useful for many different applications. For example, the quality and safety of many perishable products are strongly influenced by the product age and/or temperature to which the product has been exposed during its lifetime (that is during processing, handling, storage, distribution and so forth). Examples include chilled, frozen or other easily perishable foods, medical and pharmaceutical products, cut flowers, batteries and so forth. For such products the product temperature must be kept at acceptable levels and the aptitude to reconstruct the product's time/temperature history by means of TTIs is very desirable (Bogh-Sorensen, L.; Löndahl, G.; Temperature indicators and time-temperature integrators; 3^{rd} IIR Informatory Note on Refrigeration and Food; Ecolibrium, 2005, 5, published by AIRAH). Various TTIs, in many different forms, including for example, tags, labels and packaging forms have been proposed for monitoring such products (Riva, M.; Piergiovanni, L.; Schiraldi, A.; Performance of Time-Temperature Indicators in the Study of Temperature Exposure of Packaged Fresh Foods; Packag. Technol. Sci. 2001, 14, 1-9). Other application examples are indicators, which confirm that a heat treatment has been adequate, for example tags or sensors showing that food has been sufficiently cooked. Security features which may allow one to detect tampering involving heat treatment in delamination attempts represent yet another illustrative example for the use of TTIs (Uhm, J. S.; Giesa, R.; Schmidt, H. W.; Orientation and in-situ photopolymerization of a diacetylene monomer in gel-processed ultra-high molecular weight polyethylene: Films with several optical security features; Adv. Funct Mater., 2002, 12, 441). Many other examples of applications where time/temperature history tracking is important are known in the transportation industry, including automotive and aerospace industries, the electronics industry, sports and the military complex. However, as is evident from these examples, TTI technology is of major importance for any application where information about the time/temperature history is useful.

Various kinds of TTIs have been described in the prior art and many different operation principles have been proposed (R. I. Ezrielev, R. B. Barrett, U.S. Pat. No. 5,476,792, 1995. K. A. Narayan, U.S. Pat. No. 5,529,931, 1996. T. Prusik, R. M. Arnold, S. C. Feilds, U.S. Pat. No. 6,042,264, 2000. A. V. Bray, U.S. Pat. No. 6,158,381, 2000. M. J. Simons, J. A. Weldy, U.S. Pat. No. 6,214,623, 2001. M. J. Simons, U.S. Pat. No. 6,514,462, 2003. T. Prusik, R. M. Arnold, A. P. Piechowski, U.S. Pat. No. 6,544,925, 2003). The common feature of these devices is a time-temperature dependent process, which for example can be physical, mechanical, chemical, electrochemical, biochemical, enzymatic or microbiological in nature. The process typically results in an irreversible, measurable and often visual response, for example in the form of a mechanical deformation, color development or color movement, pH change, fluorescence change and so forth. The rate of change is usually temperature-dependent, increasing at higher temperatures similarly to most physicochemical reactions. It is desirable that the rate of change is predictable and displays a response function that matches with that of a process to be monitored, for example the quality function of perishable foods (Taoukis, P; Labuza, T. P; Chemical time-temperature integrators as quality monitors in the chill chain; in Proceedings of the Intemational Symposium Quimper Froid'97; Predictive Microbiology of chilled foods. June 16-18, (1998).

TTIs may or may not exhibit a threshold temperature or narrow threshold temperature range, below which the rate of change is zero or small compared to the rates of change above the threshold temperature. TTIs which display a threshold temperature or narrow threshold temperature range and which display a high rate of change above this threshold are often used and referred to as threshold temperature indicators. Such devices typically provide information whether or not a certain threshold temperature has been reached or exceeded but do not provide information about the amplitude or the duration of the possible temperature exposure (Bogh-Sorensen, L.; Löndahl, G.; Temperature indicators and time-temperature integrators; 3^{rd} IIR Informatory Note on Refrigeration and Food; Ecolibrium, 2005, 5, published by AIRAH). TTIs which display a slower rate of change in a temperature regime of interest than the above examples can show a response that reflects the cumulative time/temperature exposure. These devices can integrate, in a single measurement, the full time/temperature history to which they have been exposed to and are therefore often used and referred to as time-temperature integrators (U.S. Pat. No. 3,954,011, 1971. International Patent Application WO 96/28714, 1996. U.S. Pat. No. 4,043,871, 1977. U.S. Pat. No. 4,284,719, 1981). These devices may or may not display a threshold temperature or narrow threshold temperature range, below which the rate of change is zero or small compared to the rates of change above the threshold temperature. With respect to the scope of the present invention, the terms time-temperature indicator, TTI device and TTI shall embrace all of the above devices for measuring time-temperature history and or exposure and shall include all kinds of devices and other embodiments which can be used to monitor the time/temperature history, for example of certain objects or places.

It is desirable that TTI materials, TTIs and devices including the same (i) are inexpensive to manufacture, (ii) display an easily measurable, time-temperature dependent, irreversible, color change that reflects the full or partial temperature history, (iii) display a predictable time-temperature behavior, (iv) have high accuracy and reproducibility, (v) do not need to be activated or are easy to activate, with a definitive point of activation, (vi) can be stored prior to use, without a reaction being initiated during storage, (vii) are resistant to physical, chemical and mechanical abuse, (viii) display a signal that is easy to read and understand, (ix) track the temperature as closely as possible, and (x) are tamper-proof. In addition, the TTI reaction/process must be flexible so that the TTI's response function can readily be tailored for different applications. Unfortunately, as is well known in the art, the presently available TTI materials, TTIs, devices, and systems suffer from severe limitations (Bogh-Sorensen, L.; Löndahl, G.; Temperature indicators and time-temperature integrators; 3^{rd} IIR Informatory Note on Refrigeration and Food; Ecolibrium, 2005, 5, published by AIRAH). During the last 30 years numerous TTI systems have been proposed and more than 200 such devices have been patented; however, unfortunately only few of these have reached the prototype and even fewer the market stage (Riva, M.; Piergiovanni, L.; Schiraldi, A.; Performance of Time-Temperature Indicators in the Study of Temperature Exposure of Packaged Fresh Foods; Packag. Technol. Sci. 2001, 14,1-9. Selman, J. D.; Time-temperature indicators; in Active Food Packaging; Rooney, M. L. et al.; Eds.; Blackie Academic and Professional, London: 1995, 215-237), which is an indication for the severe technical limitations and drawbacks of these prior art technologies.

Some of the TTIs presently used are based on diffusion, where a pad is saturated with a migrating chemical, serving as a reservoir (U.S. Pat. No. 3,954,011, 1971. International Patent Application WO 96/28714, 1996). The migrating chemical, most commonly an ester, displays a specific melting point (m.p.) that defines the threshold temperature and contains a dye that allows for visual indication. Upon activation, which is usually accomplished by physically breaking a separation membrane, the pad with the chemical substance and the dye is brought in contact with a graded track or “wick” along which the dyed chemical moves. Diffusion occurs if the temperature is above the m.p. of the chemical and the speed of diffusion is temperature-dependent, so that the distance the substance has moved is a measure of the cumulative time-temperature history. The complex device architecture, the need for activation (success of which may be difficult to assess), and mechanical fragility are distinctive disadvantages of these systems.

Other TTI systems are based on chemical reactions. For example, some TTIs rely on the controlled enzymatic hydrolysis of a lipid substrate, which results in a decrease in pH (U.S. Pat. No. 4,043,871, 1977. U.S. Pat. No. 4,284,719, 1981). The pH change causes a dye to change color; measurement of pH change is another read-out possibility, as is the monitoring with a portable calorimeter (Taukis, P S.; Labuza, T. P.; Applicability of Time Temperature Indicators as shelf Life Monitors of Food Products; J. Food. Sci. 1989, 54, 783-788). Before activation, these indicators consist of two separate compartments, for example in the form of plastic mini-pouches, containing an aqueous solution of a lipotic enzyme and the lipid substrate, respectively. Different combinations of enzyme/substrate combinations and concentrations can be employed to give a variety of response functions and temperature dependencies. Also in this case, complex device architecture, the need for activation (success of which may be difficult to assess), and mechanical fragility are distinctive disadvantages. Furthermore, these indicators must often be kept frozen until they are used, to prevent the enzymes and chemicals from being spoiled. Another family of TTIs that rely on chemical reactions is based on solid-state polymerizations, for example of substituted diacetylene monomers (U.S. Pat. No. 3,999,946, 1976. U.S. Pat. No. 4,228,126, 1980). Upon exposure to heat these monomers polymerize to result in colored polymers and the color change or change in reflectance is a measure for the time/temperature history. In this case, the main disadvantages are the need to keep the indicators deep frozen before storage and the fact that the polymerization reaction can also be triggered by other stimulation such as radiation, making the system vulnerable to errors.

Recently, some photoluminescent (PL) materials have been proposed to be useful as TTIs (Crenshaw, B.; Weder, C.; Thermally Induced Color Changes in Melt-Processed Photoluminescent Polymer Blends; Adv. Mater. 2005, 17, 1471-1476. PCT/US2003/019532). The approach disclosed in the prior art relies on the phase separation of initially molecularly mixed blends of excimer-forming PL dyes and amorphous host polymers with a glass transition temperature (T_{g}) in a temperature regime of interest. This sensing scheme involves kinetically trapping thermodynamically unstable molecular mixtures of the excimer-forming photoluminescent sensor dyes in the glassy polymer, for example by melt-processing and rapid quenching below T_{g}. These materials display photoluminescence spectra that are dominated by monomer emission, that is, emission from well dispersed or dissolved individual sensor molecules. Subjecting these materials to temperatures above T_{g} leads to permanent and pronounced changes of their PL emission spectra, as a result of phase separation and excimer formation. These prior art TTI materials and devices display the disadvantage that they are limited in application since the read-out is a change of the photoluminescence spectrum or color of the emitted light (not absorption spectrum or color) and therefore a special light source, for example an ultraviolet lamp, is required to interrogate these prior art materials and devices.

In summary, despite most significant international research and development efforts, the current state of the art has failed to yield TTI materials, TTIs and devices including the same which can satisfy all of the desirable features set forth above. The need, thus, continues to exist for TTI materials, TTIs and devices including the same, and methods to produce such materials and devices which are inexpensive to manufacture, display an easily measurable, time-temperature dependent, irreversible, color change that reflects the full or partial temperature history and is easy to read and understand, display a predictable time-temperature behavior, have high accuracy and reproducibility, do not need to be activated or are easy to activate with a definitive point of activation, can be stored prior to use without a reaction being initiated during storage, track the temperature as closely as possible, are resistant to physical, chemical and mechanical abuse and are tamper proof.

### SUMMARY OF THE INVENTION

One object of the present invention to overcome the problems related to the prior art is to provide TTI materials, TTIs and devices including the same, which are inexpensive to manufacture, display an easily measurable, time-temperature dependent, irreversible, color change that reflects the full or partial temperature history and is easy to read and understand, display a predictable time-temperature behavior, have high accuracy and reproducibility, do not need to be activated or are easy to activate with a definitive point of activation, can be stored prior to use without a reaction being initiated during storage, track the temperature as closely as possible, are resistant to physical, chemical and mechanical abuse and are tamper proof.

Another object of the present invention is to provide methods for the preparation of TTI materials, TTIs and devices including the same, which are inexpensive to manufacture, display an easily measurable, time-temperature dependent, irreversible, color change that reflects the full or partial temperature history and is easy to read and understand, display a predictable time-temperature behavior, have high accuracy and reproducibility, do not need to be activated or are easy to activate with a definitive point of activation, can be stored prior to use without a reaction being initiated during storage, track the temperature as closely as possible, are resistant to physical, chemical and mechanical abuse and are tamper proof.

Another object of the present invention is to provide a method of determining the time/temperature history of an object or place by using materials or devices which display an easily measurable, time-temperature dependent, irreversible, color change.

Other objects of the present invention will become apparent to those skilled in the art in the following detailed description of the invention and the appended claims.

The present invention is based on our surprising finding that the foregoing and other objects are achieved by making and using materials that exploit a new physico-chemical mechanism, which hereinafter is explained in detail. One approach, which forms the basis of certain embodiments of the present invention, relies on the phase separation of initially molecularly mixed blends of at least one aggregachromic dye and at least one fully or partially amorphous or semicrystalline carrier material in a time/temperature regime of interest. The invention involves trapping molecular mixtures of the aggregachromic dye in the carrier material, for example by melt-processing and rapid quenching into a temperature regime in which the aggregachromic dye molecules display little mobility for aggregation, for example at temperatures close to or below the T_{g} of the material. These materials display absorption characteristics that show a significant contribution of monomer absorption, that is, optical absorption of well dispersed or dissolved individual aggregachromic dye molecules. Subjecting these materials to time/temperature exposure, usually involving heating, increases the mobility for aggregation of the aggregachromic dye molecules and in appropriate compositions leads to pronounced changes of their absorption, as a result of phase separation and aggregate formation. Minimizing the amount of the aggregachromic dye in the carrier material necessary to cause aggregation of the aggregachromic dye upon time/temperature exposure is advantageous, for example since this maximizes the color change upon aggregation and reduces costs. We surprisingly found that this can be accomplished by derivatizing the aggregachromic dyes according to this invention with long alkyl groups. This finding is not only of importance to materials and TTIs comprising aggregachromic dyes but also dramatically improves the performance of prior art materials and TTIs (Crenshaw, B.; Weder, C.; Thermally Induced Color Changes in Melt-Processed Photoluminescent Polymer Blends; Adv. Mater. 2005, 17, 1471-1476) that comprise excimer-forming photoluminescent dyes. Furthermore, we found that semicrystalline carrier materials lead to embodiments of the present inventions that can retain mechanical integrity above their glass transition temperature, while amorphous carrier materials lose their mechanical integrity above their glass transition temperature, making semicrystalline carrier materials a preference. Also this discovery is not only of importance to materials and TTIs comprising aggregachromic dyes but also dramatically improves the performance of prior art materials and TTIs that comprise excimer-forming photoluminescent dyes (Crenshaw, B.; Weder, C.; Thermally Induced Color Changes in Melt-Processed Photoluminescent Polymer Blends; Adv. Mater. 2005, 17, 1471-1476).

Embodiments of this invention include new TTI materials that comprise at least one fully or partially amorphous or semicrystalline carrier material and at least one aggregachromic dye and which display an easily measurable, time-temperature dependent, irreversible, color change. In preferred embodiments of the present invention, this color change can be detected with the unassisted eye. In other preferred embodiments of the present invention, this color change can be detected with appropriate analytic instruments such as spectrophotometers, colorimeters or other appropriate equipment. With respect to the scope of the present invention the term aggregachromic dye defines a class of compounds selected from the groups including, but not limited to, dyes, chromophores, pigments, stains, indicators and so forth, which can display a substantial change of their optical absorption spectrum upon aggregation in the carrier material according to the invention. Preferred TTI materials that are embodiments of this invention are obtained by forming mixtures of the aggregachromic dye and the carrier material in which the aggregachromic dye lead to an initial optical absorption spectrum, which can irreversibly change upon subjection to time/temperature exposure. TTI materials according to the invention materials may display optical absorption characteristics that are dominated by the absorption of the portion of the aggregachromic dye molecules that are well dispersed or dissolved. TTI materials that are embodiments of this invention have the ability to display a change of their optical absorption characteristics upon subjection to time/temperatures exposure, for example due to aggregation of the aggregachromic dye molecules, phase changes of the material, or a change of the supramolecular architecture of the material.

A number of preferred methods, which represent embodiments of the present invention, have been discovered that allow preparation of TTI materials that comprise at least one fully or partially amorphous or semicrystalline carrier material and at least one aggregachromic dye and which display an easily measurable, time-temperature dependent, irreversible, color change. One method comprises melt-processing at least one fully or partially amorphous or semicrystalline carrier material and at least one kind of aggregachromic dye and cooling the resulting material to a temperature that is substantially below the processing temperature under conditions that prevent substantial aggregation of the aggregachromic dye. Another method comprises co-dissolving at least one fully or partially amorphous or semicrystalline carrier material and at least one kind of aggregachromic dye in a common solvent and solution-processing the resulting mixture under conditions that prevent substantial aggregation of the aggregachromic dye.

Another embodiment of the invention are TTI devices based on one or more materials that comprise at least one fully or partially amorphous or semicrystalline carrier material and at least one aggregachromic dye and which display an easily measurable, time-temperature dependent, irreversible, color change.

Another embodiment of the present invention is a method of determining the time/temperature history of an object or place by using materials or TTI devices which display an easily measurable, time-temperature dependent, irreversible, color change.

Further embodiments of the invention are new materials and TTI devices thereof that comprise at least one partially amorphous or semicrystalline carrier material and at least one excimer-forming photoluminescent dye and which display an easily measurable time-temperature dependent change of their photoluminescence spectrum. Further embodiments of the invention are new materials and TTI devices thereof that comprise at least one amorphous, partially amorphous or semicrystalline carrier material and a small amount of at least one excimer-forming photoluminescent dye and which display an easily measurable time-temperature dependent change of their photoluminescence spectrum. Methods to produce such photoluminescent TTI materials and devices are also embodiments of the present invention.

In one preferred embodiment, the composition is capable of undergoing a measurable time-temperature color change, comprising at least one fully or partially amorphous or semicrystalline carrier material and at least one aggregachromic dye, wherein the combined effects of time and temperature are capable of causing an irreversible color change in the composition.

In another embodiment, the method for producing a time-temperature indicator material comprises the steps of combining at least one fully or partially amorphous or semicrystalline carrier material and at least one aggregachromic dye to produce a first mixture wherein the aggregachromic dye is substantially dispersed or dissolved in the carrier material, and forming a body from the first mixture, wherein the body has an initial optical absorption spectrum and is capable of exhibiting a second optical absorption spectrum after exposure to a temperature for a period of time.

In a further embodiment, the method for producing a time-temperature indicator material comprises the steps of: (i) melt-mixing at least one fully or partially amorphous or semicrystalline carrier material and at least one aggregachromic dye at a first temperature to produce a first mixture, (ii) shaping said first mixture into a body at a second temperature, which may be higher or lower than the first temperature or the same, and (iii) cooling said body to a third temperature, wherein the body exhibits an initial optical absorption spectrum and is capable of exhibiting a second optical absorption spectrum after exposure for a period of time to at least a fourth temperature which is the same or different than the third temperature.

In yet another embodiment, the method for producing a time-temperature indicator material comprises the steps of: (i) co-dissolving at least one fully or partially amorphous or semicrystalline carrier material and an effective amount of at least one kind of aggregachromic dye to have an initial optical absorption in a common solvent to produce a first mixture, and (ii) forming a body from said mixture by removing said solvent, wherein the body is capable of exhibiting a second optical absorption spectrum after exposure to a temperature for a period of time.

In still another embodiment, the method of determining time/temperature history of an article comprises the steps of: (i) measuring the optical absorption spectrum of an article comprising at least one fully or partially amorphous or semicrystalline carrier material and at least one aggregachromic dye, wherein the combined effects of time and temperature cause an irreversible color change of the article and (ii) comparing said measurements of the optical absorption spectrum of the article with an initial optical absorption spectrum of the article.

In a further embodiment, the method for producing a time-temperature indicator material comprises the steps of: (i) co-dissolving at least one fully or partially amorphous or semicrystalline carrier material and a sufficient or effective amount of at least one kind of aggregachromic dye to have an initial optical absorption in a common solvent to produce a first solution, (ii) preparing an emulsion comprising said first solution, a liquid that serves as the continuous phase for said emulsion and optionally an emulsifying agent, (iii) evaporating some or all of said solvent to create an emulsion.

In still a further embodiment, a photoluminescent article comprises at least one carrier material and from 0.5 parts to less than 5 parts by weight of at least one photoluminescent dye per 100 parts by weight of carrier material, wherein said photoluminescent dye has the ability to form excimers, and wherein the combined effects of time and temperature can cause an irreversible change of the emission spectrum of the at least one photoluminescent dye.

In yet a further embodiment, the time-temperature color change composition comprises at least one fully or partially amorphous or semicrystalline carrier material; and an effective amount of at least one aggregachromic dye so that the composition exhibits an initial optical absorption spectrum and is capable of exhibiting a second optical absorption spectrum after exposure to a temperature for a period of time greater than a temperature at the initial optical absorption spectrum.

The terms “time-temperature indicator” “TTI device” and “TTI” broadly refer to all kinds of articles and devices including a TTI material which can be used to monitor the time/temperature history, for example of certain objects or places. The TTIs that are embodiments of this invention may be of many useful forms, for example, but not limited to, a fiber, rod, film, sheet, tape, layer, plate, coating, micro- or nanoparticle, which may be homogeneous and continuous, and may be structured or patterned, and may comprise multiple individual elements, partitions, zones or pixels or arrays thereof. The TTIs of this invention may incorporate one or more TTI materials which may be different or the same and may be combined with or integrated into other materials, for example to be applied as tags, stickers or labels, to become part of packaging materials or other objects, and so forth. The TTIs of this invention may change their physical state and shape during application and use; illustrative examples, which shall not be construed as limiting, include solidification upon application or formation of the TTI material or a precursor thereof from a solution or melt, for example as a paint, with a felt-pen, an inkjet or any other printing or application process or with a crayon comprising the TTI material.

The term “TTI material” relates to materials or compositions which comprise at least one carrier material and one aggregachromic dye and which respond to the combined effects of temperature and time with an easily measurable, time-temperature dependent, irreversible, color change, and which can be used to obtain TTIs according to this invention.

The term “aggregachromic dye” defines light-absorbing compounds such as dyes, chromophores, pigments, stains, indicators and other light-absorbing materials, which display a measurable, preferably visual color change upon aggregation in a carrier material according to the invention.

Herein the terms “absorption” and “emission” relate to optical processes.

Unless otherwise stated, herein the term “color change” is used to describe a change of an optical absorption spectrum. For the purpose of accurately determining color changes in connection with embodiments of the present invention, a UV-Vis photospectrometer, a calorimeter or visual inspection is used, and color changes of a given material, article or device shall be established by measurements conducted under about comparable conditions, that is with materials, articles or devices of about identical dimensions, quality, temperature and so forth.

In the context of embodiments of the present invention the term “irreversible” is used to indicate that a color change is under a certain conditions irreversible, which may, for example, be defined by a certain time/temperature space, which shall not be construed to mean that the color change might not be reversible under a different set of conditions.

Herein the terms “aggregachromic dye” and “carrier material” are often used to encompass both the singular and plural and where applicable should be read and understood as “one or multiple aggregachromic dyes” and “one or multiple carrier materials”.

### BRIEF DESCRIPTION OF THE DRAWINGS

The invention will be better understood and other features and advantages will become apparent by reading the detailed description of the invention, taken together with the drawings, wherein:

FIG. 1A is a schematic representation of the chemical structures of 1,4-bis-(α-cyano-4-octadecyloxystyryl)-2,5-dimethoxybenzene (C18-RG), 1,4-bis-(α-cyano-4-dodecyloxystyryl)-2,5-dimethoxybenzene (C12-RG), and 1,4-bis-(α-cyano-4-methoxy-styryl)-2,5-dimethoxybenzene (C1-RG) which represent examples of aggregachromic dyes that are useful in embodiments of the present invention.

FIG. 1B is a schematic representation of the chemical structure of 3-[4-(2-cyano-2-{4-[2-(4-ethoxy-phenyl)-vinyl]-phenyl}-vinyl)-2,5-bis-octyloxy-phenyl]-2-{4-[2-(4-ethoxy-phenyl)-vinyl]-phenyl}-acrylonitrile (C2-RY8) which represents an example of an aggregachromic dye that is useful in embodiments of the present invention.

FIG. 2 is a schematic representation of the chemical structure of 1,4-bis-(α-cyano-4-methoxystyryl)-benzene (C1-YB), a reference example outside the invention of an excimer-forming dye that does not display aggregachromic behaviour.

FIG. 3A shows the absorption spectra of a 0.0133 mM solution of C18-RG in CHCl₃ (solid) and a 1:9 CHCl₃/methanol mixture (dashed).

FIG. 3B shows the PL emission spectra of a 0.0133 mM solution of C18-RG in CHCl₃ (solid) and a 1:9 CHCl₃/methanol mixture (dashed).

FIG. 3C shows the absorption spectra of a 0.0121 mM solution of C12-RG in CHCl₃ (solid) and a 1:9 CHCl₃/methanol mixture (dashed).

FIG. 3D shows the PL emission spectra of a 0.0121 mM solution of C12-RG in CHCl₃ (solid) and a 1:9 CHCl₃/methanol mixture (dashed).

FIG. 3E shows the absorption spectra of a 0.007 mM solution of C2-RY8 in CHCl₃ (solid) and a 1:9 CHCl₃/methanol mixture (dashed).

FIG. 3F shows the PL emission spectra of a 0.007 mM solution of C2-RY8 in CHCl₃ (solid) and a 1:9 CHCl₃/methanol mixture (dashed).

FIG. 4A shows the PL emission spectra of 5% w/w PMMA/C1-YB blend films before (solid) and after (dashed) annealing the sample for 20 hours at 130° C.

FIG. 4B shows the PL emission spectra of 10% w/w PC/C1-YB blend films before (solid) and after (dashed) annealing the sample for 42 hours at 150° C.

FIG. 4C shows a picture of 10% PC/C1-YB blend films (shown under excitation with a 365 nm UV lamp) before (left) and after (right) annealing for 42 hours at 150° C.

FIG. 5A shows a picture of initially quenched blend films of PET and 0.9% w/w C18-RG upon annealing for the time and at the temperature indicated. The samples are shown under illumination with ambient light.

FIG. 5B shows a picture of initially quenched blend films of PETG and 1.1% w/w C18-RG upon annealing for the time and at the temperature indicated. The samples are shown under illumination with ambient light.

FIG. 5C shows a picture of initially quenched blend films of PETG and between 1% and 3.1% w/w C18-RG upon annealing at 100° C. for the time indicated. The samples are shown under illumination with ambient light.

FIG. 6A shows absorption spectra of an initially quenched blend film of PET and 0.9% w/w C18-RG as a function of annealing time at 100° C.

FIG. 6B shows relative intensities of ratios of the absorbances at 445 nm and 375 nm (A₄₄₅/A₃₇₅), as a function of annealing time at 100° C. Shown are data for initially quenched PET/C18-RG blends comprising 0.9% w/w of the dye. The line represents a least-square fit according to a single exponential function.

FIG. 6C shows absorption spectra of an initially quenched blend film of PET and 2% w/w C2-RY8 as a function of annealing time at 100° C.

FIG. 6D shows the color change extracted from absorption spectra as a function of time for initially quenched 1% w/w PETG/C18-RG blends (◯) annealed at 95° C. (dashed) and 100° C. (solid) or 1% w/w PETG/C2-RY8 blends (□) annealed at 110° C. (dashed) and 130° C. (solid). The relative intensities were determined from the ratios of the absorbances of at 445 nm and 375 nm (A₄₄₅/A₃₇₅) in case of PETG/C18-RG blends and 463 and 540 in case of PETG/C2-RY8 blends. The lines represent a least-square fit according to a single exponential function.

FIG. 7 shows normalized PL emission spectra of blend films based on PET and 0.9% w/w C18-RG. Shown are spectra of quenched films (solid line) and samples that were annealed for 2 hours at 100° C. (dashed line) or 120° C. (dotted line).

FIG. 8 shows normalized PL emission spectra of particles of an average diameter of about 10 μm based on blends of a poly(butyl/methylmethacrylate) copolymer with a glass transition temperature of 52° C. and about 2% w/w of C18-RG as a function of annealing time at 80° C. The particles were initially quenched from the melt to room temperature.

### DETAILED DESCRIPTION OF THE INVENTION

The present invention is based on our surprising discovery of a new physico-chemical mechanism, which hereinafter is explained in detail and which can be exploited for making TTI materials and TTI devices thereof. Most importantly, we discovered that TTI materials and TTI devices according to the present invention can be made by providing blends of at least one fully or partially amorphous or semicrystalline carrier material and at least one aggregachromic dye, in which the aggregachromic dye is initially incorporated in a molecularly dissolved or dispersed fashion as outlined below. The invention comprises the formation of predominantly molecular mixtures of the aggregachromic dye and the carrier material, for example by melt-processing and rapid quenching into a temperature regime in which the aggregachromic dye molecules display little mobility for aggregation, for example at temperatures close to or below the T_{g} of the carrier material or the T_{g} of the blend of the carrier material and the aggregachromic dye, should the T_{g} of the blend be different than that of the carrier polymer. These materials display absorption characteristics that may show a significant contribution of monomer absorption, that is, optical absorption of well dispersed or dissolved individual aggregachromic dye molecules. Subjecting these materials to time/temperature exposure, usually involving heating, increases the mobility for aggregation of the aggregachromic dye molecules and or the carrier material and leads to a measurable, preferably pronounced color change, as a result of partial or full aggregation of the aggregachromic dye molecules, phase changes of the material, or a change of the supramolecular architecture of the material.

The determination whether or not the aggregachromic dye according to the present invention is initially incorporated in a molecularly dissolved or dispersed fashion may be made by a variety of methods known in the art. For example, the absence of aggregates can often be observed by microscopic means, including standard optical microscopy, atomic force microscopy and various electron microscopy techniques. The comparison of the glass transition temperature of the neat carrier material and the aggregachromic dye/carrier polymer mixture is another possibility to ascertain the presence of molecular mixtures, as the glass transition temperature of molecular mixtures of multicomponent systems changes in a predictable manner. Likewise, the determination whether or not the aggregachromic dye according to the present invention has (partially) aggregated upon time/temperature exposure may be made by the same methods. However, it is well known in the art that the difference of molecularly mixed dispersions or solutions and aggregated systems is sometimes difficult to assess, especially if the aggregates are of a size with dimensions in the nanometer regime. As a result, as is well known to those of ordinary skill in the art, color changes that occur upon aggregating a species of interest, for example by increasing the concentration of a species of interest, changing the temperature or the nature and/or quality of the solvent are often used to asses the foregoing aspects (Leclère, P. et al.; Chem. Mater. 2004, 16, 4452-4466. Kiriy, N. et al. Macromol. Symp. 2004, 210, 359-367. Kilbinger, A. F. M. et al. J. Mater. Chem. 2000, 10, 1777-1784. Bertinelli, F. et al. Synth. Met. 2001, 122, 267-273. Xia, C. et al. Langmuir 2002, 18, 955-957. Feast, W. J. et al. Macromol. Symp. 2001, 175, 151-158. Egelhaaf, H.-J. et al. Synth. Met. 1996, 83, 221-226. Wang, Y. et al. Chem. Comm. 2004, 686687. Surin et al. Synth. Met. 2004, 147, 67-72. Nakamura, T.; Shibusawa, T. Text. Res. J. 2000, 70, 801-809) and molecular mixtures and aggregates are often distinguished based on optical properties. As will become evident from the examples included herein, tests and observations which are similar or similar in spirit to the ones referred to above or in other related prior art, and in which a color change is observed that is due to an aggregachromic dye according to the invention in a TTI material according to the invention or a TTI device according to the invention shall be used to qualify and assess the usefulness of the aggregachromic dye in embodiments of the present invention and to qualify and assess the state of dispersion as a solution as molecularly dispersed and/or dissolved and/or aggregated in the spirit and context of the present invention.

Characteristics of TTI Matenals and TTI Devices According to the Invention

According to the present invention, the TTI materials are characterized in that they comprise at least one fully or partially amorphous or semicrystalline carrier material and at least one aggregachromic dye and that they display an easily measurable, time-temperature dependent, irreversible, color change. Additional species or compounds such as processing aids, viscosity modifiers, plasticizers, stabilizers as well as other additives, modifiers, color additives and so forth might also be included as it is common practice, for example to provide desirable mechanical properties, stabilization against environmental influences, increase the appeal of the material or enhance its performance in any other way. According to the invention, all aggregachromic dyes required for the color change to occur are incorporated in the at least one fully or partially amorphous or semicrystalline carrier material. According to the present invention, the color change displayed by the TTI materials and devices can be detected with appropriate analytic instruments such as spectrophotometers, calorimeters or even by an unassisted human eye in some embodiments or other appropriate equipment. The color change displayed by embodiments of this invention is characterized by one or more of the following features in the wavelength regime between 200 and 800 nm: (i) increase or decrease of absorbance at a given wavelength by more than 5%, (ii) shift of the maximum of an absorption band by more than 5 nm, (iii) appearance of a new absorption band, and (iv) disappearance of a previously existing absorption band. In preferred embodiments of the present invention, said wavelength regime is between 300 and 700 nm, said increase or decrease of absorbance at a given wavelength is by more than 10%, or said shift of the maximum of an absorption band is by more than 10 nm, or a combination thereof. In more preferred embodiments of the present invention, said wavelength regime is between 300 and 700 nm, said increase or decrease of absorbance at a given wavelength is by more than 20% or said shift of the maximum of an absorption band is by more than 20 nm or a combination thereof. In even more preferred embodiments of the present invention, said wavelength regime is between 300 and 700 nm, said increase or decrease of absorbance at a given wavelength is by more than 50% or said shift of the maximum of an absorption band is by more than 50 nm or a combination thereof. In most preferred embodiments of the present invention, this color change can be detected with the unassisted human eye.

Minimizing the amount of the aggregachromic dye in the carrier material necessary to cause aggregation of the aggregachromic dye upon time/temperature exposure is advantageous, for example since this maximizes the color change upon aggregation and reduces costs. We surprisingly found that this can be accomplished by derivatizing the aggregachromic dyes according to this invention with long alkyl groups. In a preferred embodiment, the concentration of aggregachromic dye in the carrier material is generally less than 30% or 10% by weight (w/w), i.e. less than 30 parts or 10 parts per 100 parts by weight of the carrier material, respectively. Desirably, the concentration of aggregachromic dye in the carrier material is less than 5 % by weight (w/w). Preferably, the concentration of aggregachromic dye in the carrier material is less than 2% by weight (w/w). Most preferably, the concentration of aggregachromic dye in the carrier material is less than about 1% by weight (w/w). On the other hand, especially, but not limited to, the cases where the extinction coefficient of the aggregachromic dye is low or where the thickness of the TTI material or device is low, the absorption of the TTI material according to the present invention may be undesirably low if the concentration of aggregachromic dye in the carrier material is below a certain concentration. In a preferred embodiment, the concentration of aggregachromic dye in the carrier material is generally more than 0.001% by weight (w/w). Desirably, the concentration of aggregachromic dye in the carrier material is more than 0.01% by weight (w/w). Preferably, the concentration of aggregachromic dye in the carrier material is more than 0.1% by weight (w/w). Most preferably, the concentration of aggregachromic dye in the carrier material is more than 0.5% by weight (w/w). Furthermore, as shown by the examples herein, we found that semicrystalline carrier materials are preferred over amorphous carrier materials, since semicrystalline carrier materials can retain mechanical integrity above their glass transition temperature, while amorphous carrier materials lose their mechanical integrity above their glass transition temperature. This discovery is not only of importance to materials and TTIs comprising aggregachromic dyes but also dramatically improves the performance of prior art materials and TTIs that comprise excimer-forming photoluminescent dyes (Crenshaw, B.; Weder, C.; Thermally Induced Color Changes in Melt-Processed Photoluminescent Polymer Blends; Adv. Mater. 2005, 17, 1471-1476).

The TTIs that are embodiments of this invention may be of many useful forms as is apparent from the literature on TTIs cited herein, for example, but not limited to, a fiber, rod, film, sheet, tape, layer, plate, coating, micro- or nanoparticle, which may be homogeneous and continuous, and may be structured or patterned, and may comprise multiple individual elements, partitions, zones or pixels or arrays thereof. The TTIs of this invention may incorporate one or more TTI materials which may be different or the same and may be combined with or integrated into other materials, for example to be applied as tags, stickers or labels, to become part of packaging materials or other objects, and so forth. The TTIs of this invention may change their physical state and shape during application and use; illustrative examples, which shall not be construed as limiting, include solidification upon application or formation of the TTI material or a precursor thereof from a solution or melt, for example as a paint, with a felt-pen, an inkjet or any other printing or application process or with a crayon comprising the TTI material.

The Aggregachromic Dye

The criteria for the selection of aggregachromic dyes that might be used for embodiments of the present invention will become apparent to those skilled in the art by the guidelines and examples given below. To avoid any replication from the prior art, all the below mentioned literature references related to appropriate species are herewith incorporated by reference, and thus included in, and part of the present invention.

Aggregachromic dyes are light-absorbing compounds such as dyes, chromophores, pigments, stains, indicators and other light-absorbing materials, which display a measurable color change upon aggregation in said carrier material. Aggregachromic dyes may be inorganic or organic and may be of low-molecular weight or may be polymers and may be photoluminescent or not, or combinations thereof. Most importantly, to be useful for embodiments of the present invention, the aggregachromic dye must display a color change upon changing from unaggregated to aggregated form, which is characterized by one or more of the following features in the wavelength regime between 200 and 800 nm, preferably between 300 and 700 nm: (i) increase or decrease of absorbance at a given wavelength, (ii) shift of the maximum of an absorption band, (iii) appearance of a new absorption band, and (iv) disappearance of a previously existing absorption band. As is evident from the examples given below and the literature cited herein, compounds that display electronic ground-state interactions such as for example charge-transfer complexes, or conformational changes between unaggregated and aggregated state, or other changes of their electronic ground state upon aggregation are suitable candidates for the aggregachromic dye to be useful for embodiments of the present invention. Embodiments of this invention can comprise one or multiple types of aggregachromic dyes. If only one aggregachromic dye is used, the color change typically occurs through self-aggregation of the aggregachromic dye. If more than one kind of aggregachromic dye are used, the color change can occur by multiple aggregation types, including for example self-aggregation of the different kinds of aggregachromic dye or mixed aggregation of mutually compatible kinds of aggregachromic dyes, which individually may or may not display aggregachromic behavior, such as for example certain charge-transfer complexes between donor and acceptor compounds (Horváth, O.; Stevenson, K. L.; Charge Transfer Photochemistry of Coordination Compounds; Wiley-VCH 1992. Foster, R.; Organic charge-transfer complexes, Academic Press: London 1969). Suitable, representative examples that can be useful as aggregachromic dyes can be found in, for example: Green, F. J. The Sigma-Aldrich Handbook of Stains, Dyes and Indicators, Aldrich Chemical Co.: Milwaukee, Wis. 1990; Zollinger, H. Color Chemistry: Syntheses, Properties, and Application of Organic Dyes and Pigments, John Wiley and Sons Inc. 2004; Marmion, D. M. Handbook of U.S. Colorants: Foods, Drugs, Cosmetics, and Medical Devices, John Wiley and Sons Inc. 1991; Hunger, K., Ed. Industrial Dyes: Chemistry, Properties, Applications, Wiley-VCH 2003; Hunger, K., Ed. Industrial Pigments: Production, Properties, Applications, Wiley-VCH 2004; Horváth, O.; Stevenson, K. L.; Charge Transfer Photochemistry of Coordination Compounds; Wiley-VCH 1992. Foster, R.; Organic charge-transfer complexes, Academic Press: London 1969 and many other sources. Tests which probe if a certain compound displays ground-state interactions may be useful in the context of the present invention and may involve testing color changes that occur upon increasing the concentration of a species of interest, changing the temperature or the nature and/or quality of the solvent may be useful, as for example described in the prior art (Leclere, P. et al.; Chem. Mater. 2004, 16, 4452-4466. Kiriy, N. et al. Macromol. Symp. 2004, 210, 359-367. Kilbinger, A. F. M. et al. J. Mater. Chem. 2000, 10, 1777-1784. Bertinelli, F. et al. Synth. Met. 2001, 122, 267-273. Xia, C. et al. Langmuir 2002, 18, 955-957. Feast, W.J. et al. Macromol. Symp. 2001, 175, 151-158. Egelhaaf, H.-J. et al. Synth. Met. 1996, 83, 221-226. Wang, Y. et al. Chem. Comm. 2004, 686-687. Surin et al. Synth. Met. 2004, 147, 67-72. Nakamura, T.; Shibusawa, T. Text Res. J. 2000, 70, 801-809) and the examples given herein. However, these tests alone cannot make a reliable prediction regarding the suitability of a compound as the aggregachromic dye useful for embodiments of the present invention.

It should be apparent to those of ordinary skill in the art that the electronic ground-state interactions or other electronic ground state changes which make aggregachromic dye useful for embodiments of the present invention are different from the ground-state/excited state interactions exploited in prior art materials and TTIs (Crenshaw, B.; Weder, C.; Thermally Induced Color Changes in Melt-Processed Photoluminescent Polymer Blends; Adv. Mater. 2005, 17, 1471-1476) that comprise excimer-forming photoluminescent dyes. It is well known, and will also be evident from the examples provided herein, that there is often no or little correlation between a compound's ability to form ground-state interactions or other electronic ground state changes and excimers.

Another most important requirement for the aggregachromic dye to be useful for embodiments of the present invention is that it can be incorporated in a carrier material in a molecularly dispersed or dissolved fashion (as opposed to phase separated fashion) and that it can be caused to aggregate upon exposure to time/temperature. As a guideline, as is evident from the examples given below and the prior art (Wurthner, F.; Ed. Supramolecular Dye Chemistry, Series: Topics in Current Chemistry 258, Springer 2005), this can often be achieved by selecting aggregachromic dye that displays a finite but preferably small solubility in the carrier material as well as appropriate non-covalent interactions among each other as well as with the carrier material. If the solubility in the carrier material is too high, a significant fraction of the aggregachromic dye will not aggregate when exposing a TTI material according to the present invention to time/temperature and as a result the color change upon exposure to time/temperature will be limited. On the other hand, if the solubility of the aggregachromic dye in the carrier material is too low, since a significant fraction of the aggregachromic dye will not be able to initially be well-dispersed in a TTI material according to the present invention, unless a very low concentration is used, and as a result the color change upon exposure will also be limited.

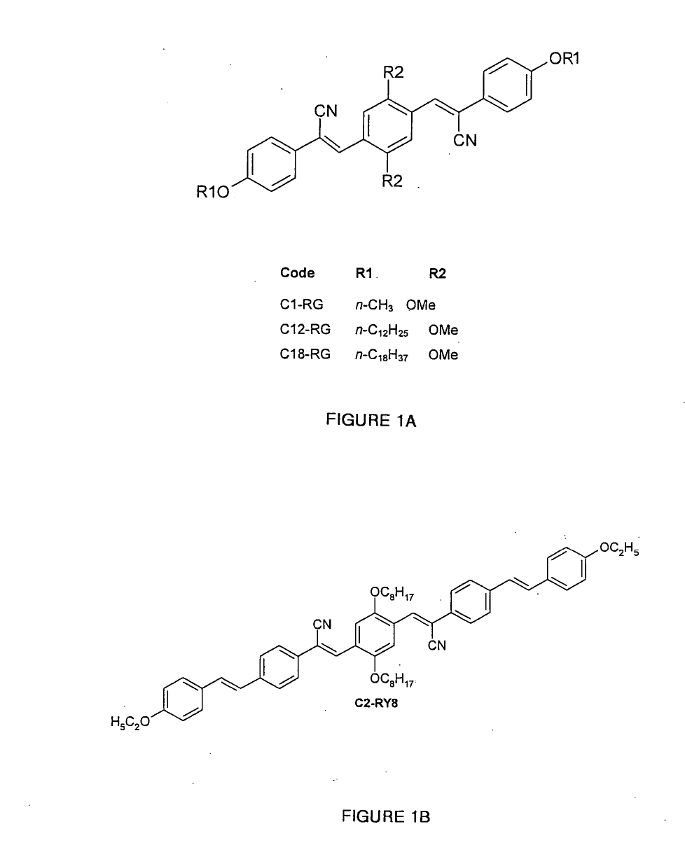

We have found, as is evident from the examples given below, that, for example the small molecular compounds 1,4-bis-(α-cyano-4-octadecyloxystyryl)-2,5-di-methoxybenzene, herein designated as C18-RG, 1,4-bis-(α-cyano-4-dodecyloxystyryl)-2,5-dimethoxybenzene herein designated as C12-RG, 1,4-bis-(α-cyano-4-methoxy-styryl)-2,5-dimethoxybenzene herein designated as C1-RG, and 3-[4-(2-cyano-2-{4-[2-(4-ethoxy-phenyl)-vinyl]-phenyl)vinyl)-2,5-bis-octyloxy-phenyl]-2-{4-[2-(4-ethoxyphenyl)-vinyl]-phenyl}-acrylonitrile herein designated as C2-RY8 when utilized in an amount generally greater than 0.5 part, desirably greater than 1.0 part, and preferably 2.0 parts per 100 parts by weight of the carrier material (FIGS. 1A and 1B), are particularly useful as aggregachromic dyes in embodiments of the present invention. These aggregachromic dyes are members of a family of oligophenylenevinylene compounds, which may include other compounds of the general formula:

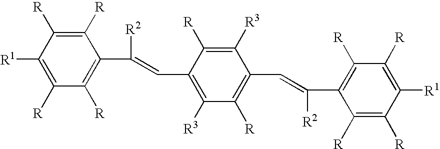

where R² may be any group which affects the desired physical or electronic properties of the compound including but not limited to H, straight chain, branched or cyclic saturated alkyl, alkenyl, or alkynyl, hydroxy alkyl, alkyloxy, carboxy alkyl, aryl, or substituted aryl, but preferably is an electron withdrawing group, such as, but not limited to, cyano, halogen, Cl, F, Br, C(═O)R, C(═O)OR, C(═O)NR₂, CF₃, CN, S(O)₂OH, NO₂, and N⁺R₄; R, R¹, and R³ may be any group which affects the desired physical or electronic properties of the compound, such as, but not limited to H, straight chain, branched or cyclic saturated alkyl, alkenyl, or alkynyl, hydroxy alkyl, alkyloxy, carboxy alkyl, aryl, or substituted aryl such as styryl or substituted styryl. In a preferred embodiment, at least one R¹ or R³, independently, are linear or branched alkyl or alkyloxy groups having 6 or more carbon atoms or comprise linear or branched alkyl or alkyloxy groups having 6 or more carbon atoms, with 6 to about 36 carbon atoms desired and about 8 to about 18 carbon atoms preferred.

The Carrier Material—The criteria for the selection of carrier materials that might be used for embodiments of the present invention will become apparent to those skilled in the art by the guidelines and examples given below. To avoid any replication from the prior art, all the herein mentioned literature references related to appropriate species are herewith incorporated by reference, and included in, and part of the present invention.

The main function of the carrier material is to regulate the aggregation of the aggregachromic dye. This is achieved in one embodiment by selecting and using carrier materials that allow for the initial incorporation of the aggregachromic dye in a fashion in which substantial aggregation of the aggregachromic dye is prevented. The examples included herein teach that this is, for example, achieved in one embodiment by limiting the mobility for aggregation of the aggregachromic dye, for example by selecting a carrier material that displays a thermal transition such as a glass transition in a temperature regime of interest and exploiting that the translational mobility is low at temperatures close to or below this transition. Further, it is desirable that subjecting these materials to time/temperature exposure increases the mobility for aggregation of the aggregachromic dye molecules. This can be achieved by selecting a carrier material that displays a thermal transition such as a glass transition in a temperature regime of interest and exploiting that the translational mobility increases as the temperature is raised close to or above the thermal transition. The desire to intimately incorporate the aggregachromic dye into carrier material makes it preferable that the carrier material be a fully or partially amorphous or semicrystalline material which may be organic or inorganic. As will become evident from the below description, and the examples and the prior art cited herein, the response function of the TTI materials and devices according to the present invention depends on the ability of the aggregachromic dyes to aggregate in the carrier material and can therefore be influenced and controlled by the nature of the latter. Important parameters include, amongst others, the thermal transition temperatures (in particular glass transition temperature and/or melting temperature), viscosity, molecular weight, entanglement density, free volume and crystallinity of the carrier material. For example, amorphous organic or inorganic glasses can display a well-defined glass transition temperature below which aggregation of the aggregachromic dyes does not occur or is exceedingly slow. The same materials can display low viscosity (due to low molecular weight, the absence of any chain entanglements and the absence of any crystallinity) above the glass transition, which can result in very rapid aggregation of the aggregachromic dyes if the TTI material or device is exposed to a temperature that exceeds the glass transition of the carrier material. Thus, TTI materials and TTIs comprising amorphous inorganic or organic glasses as carrier material can display a threshold temperature or narrow threshold temperature range below which virtually no color change occurs and which display a high rate of color change above this threshold. Such TTIs may, for example, be especially useful as threshold temperature indicators which can provide information whether or not a certain threshold temperature has been reached or exceeded. Another example for carrier materials according to the present invention are fully or partially amorphous or semicrystalline organic or inorganic polymers such as the examples found in Odian, G.; Principles of Polymerization, 4^{th} Edition; Wiley-lnterscience: Hoboken, N.J. 2004 and Mark, H. F. et al.; Eds. Encyclopedia of Polymer Science and Technology, 3d Edition, John Wiley & Sons, 2003, which can display a narrow or broad glass transition temperature below which aggregation of the aggregachromic dyes does not occur, is exceedingly slow, or slow. The same materials can display comparably high viscosity (due to high molecular weight, the presence of chain entanglements and the possible presence of crystallinity) above the glass transition, which can result in slow aggregation of the aggregachromic dyes if the TTI material or device is exposed to a temperature that matches or slightly exceeds the glass transition of the carrier material; in case of these carrier materials the aggregation rate of the aggregachromic dyes and/or the rate of color change can further increase by exposure to still higher temperatures and the rate of the color change can depend on the temperature in a predictable manner, such as for example an Arrhenius-type law. Such TTI materials and TTIs which display a slower rate of change in a temperature regime of interest that scales in a predictable manner with the temperature can integrate, in a single measurement, the full time/temperature history to which they have been exposed to and may be particularly useful as time-temperature integrators. Examples of fully or partially amorphous or semicrystalline organic or inorganic polymers, which may be employed in embodiments of the present invention include, without limitation, cyclic olefin polymers and copolymers, poly(acrylate)s such as poly(methyl methacrylate), poly (methacrylate), and poly(butyl acrylate), poly(butyl methacrylate); poly(acrylamide); poly(acrylonitrile); vinyl polymers such as poly(vinylchloride), poly(vinylidenechloride), poly(vinylfluoride), poly(tetrafluoroethylene), poly(chlorotrifluoroethylene), poly(vinylacetate), poly(vinyl-alcohol), poly(2-vinylpyridine) poly(vinyl butyral); poly(styrene); poly(acrylonitrile); copolymers of all the above, such as ABS and other styrene copolymers; ethylene/vinyl acetate copolymers; polyacrylate copolymers such as poly(methylmethacrylate butylmethacrylate) copolymers, polyamides; such as polyamide 6 and 6,6, polyamide 12, polyamide 4,6; polyesters, such as poly(ethylene terephthalate), poly(ethylene terephthalate glycol), poly(butylene terephthalate), poly(ethylene naphthalate), and amorphous poly(ethylene terephthalate) and poly(ethylene terephthalate) copolymers; poly(carbonate)s; polyurethanes, poly(aryl sulfones); poly(phenyleneoxide); polyolefins such as polyethylenes (including LLDPE, LDPE, HDPE, UHMWPE and other polyethylenes) and poly(propylene); thermoset resins such as phenol formaldehyde resins (resoles, novolacs); epoxy resins; regenerated cellulose, such as cellophane, cellulose acetate, cellulose acetate butyrate, as well as blends or composites comprising two or more of the heretofore mentioned or other compounds. Additionally, the carrier material may be an elastomer, such as, styrene-butadiene copolymers, polybutadiene, ethylene-propylene copolymers, polychloroprene, polyisoprene, nitrile rubbers, silicone rubbers, thermoplastic elastomers. The properties and functionality incorporated and displayed by the carrier material are chosen such that the solubility and aggregation characteristics of the aggregachromic dye in the carrier material meet the desired application.

As noted heretofore, carrier material and aggregachromic dye can be different species, but they might also be combined into one. To combine carrier material and aggregachromic dye, these species may be covalently linked by adequate covalent, ionic, or hydrogen bonds (which should not adversely influence the required functionality of carrier material and aggregachromic dye) and combined, for example in one small molecule, oligomer or polymer or copolymer. Other options include inorganic or organic/inorganic hybrid materials, for example salts or complexes serving as both carrier material and aggregachromic dye.

In a preferred embodiment, in order to produce a measurable color change from an initial optical absorption spectrum to a second optical absorption spectrum, a composition including a carrier material and an aggregachromic dye is subjected to a temperature, for a period of time, generally greater than about the glass transition temperature of the composition, desirably greater than about 10° C. or about 20° C. below the glass transition temperature of the composition, and preferably greater than or equal to the glass transition temperature of the composition.

Methods for the Preparation of TTI Materials and TTI Devices Thereof

The criteria for the selection of methods that are used for the fabrication of TTI materials and TTI devices thereof as various embodiments of the present invention will become apparent to those skilled in the art by the guidelines and examples given below. To avoid any replication from the prior art, all the below mentioned literature references related to appropriate methods are herewith incorporated by reference, and thus included in, and part of the present invention.

According to a preferred embodiment of the present invention, TTI materials and TTI devices are produced by forming mixtures of the aggregachromic dye and the carrier material in which the aggregachromic dye causes an initial optical absorption spectrum, which can irreversibly change to at least a second or subsequent optical absorption spectrum different than the first optical absorption spectrum upon subjection to time/temperature exposure, preferably involving heating. We found that this can be accomplished by a variety of methods.

A first method that is an embodiment of the present invention involves the steps of (i) melt-mixing of least one fully or partially amorphous or semicrystalline carrier material and a sufficient or effective amount of at least one aggregachromic dye to have an initial optical absorption at a first temperature to result a first mixture, (ii) shaping said first mixture into a body at the a second temperature, which may be higher or lower than the first temperature or the same, and (iii) cooling said body to a final temperature, where said first temperature and said second temperature and said third temperature and the rate of cooling said body are chosen to suppress substantial aggregation of the aggregachromic dye.

A second method that is an embodiment of the present invention involves the steps of (i) co-dissolving at least one fully or partially amorphous or semicrystalline carrier material and a sufficient or effective amount of at least one kind of aggregachromic dye to have an initial optical absorption in a common solvent to result a first mixture, (ii) preparing a body from said mixture by forming and removing the solvent, where said solvent is removed at a temperature and rate chosen to suppress substantial aggregation of the aggregachromic dye.

A third method that is an embodiment of the present invention involves at least the steps of (i) co-dissolving at least one fully or partially amorphous or semicrystalline carrier material and a sufficient or effective amount of at least one kind of aggregachromic dye to have an initial optical absorption in a common solvent to produce a first solution, (ii) preparing an emulsion comprising said first solution, a liquid that serves as the continuous phase for said emulsion and optionally an emulsifying agent, (iii) evaporating some or all of said solvent to create an emulsion. Optional steps such as heating/quenching cycles are employed in some embodiments to obtain the TTI material so that the aggregachromic dye is appropriately dispersed. As will become evident from the examples given herein, this embodiment is a preferred method for the preparation of TTI materials in the form of about spherical particles with diameters in the range of a few nanometers to a few millimeters, and in particular between about 10 nm and 100 μm.

### EXAMPLE A (COMPARATIVE EXAMPLE)

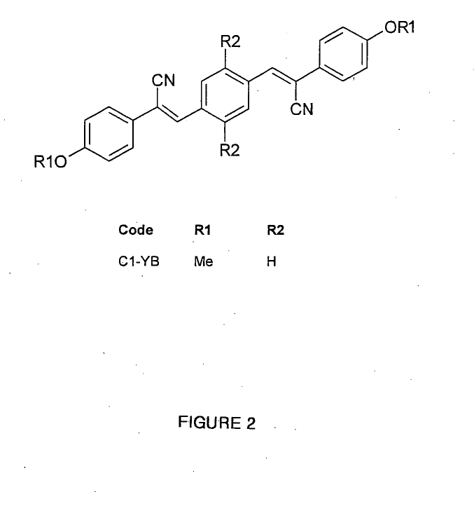

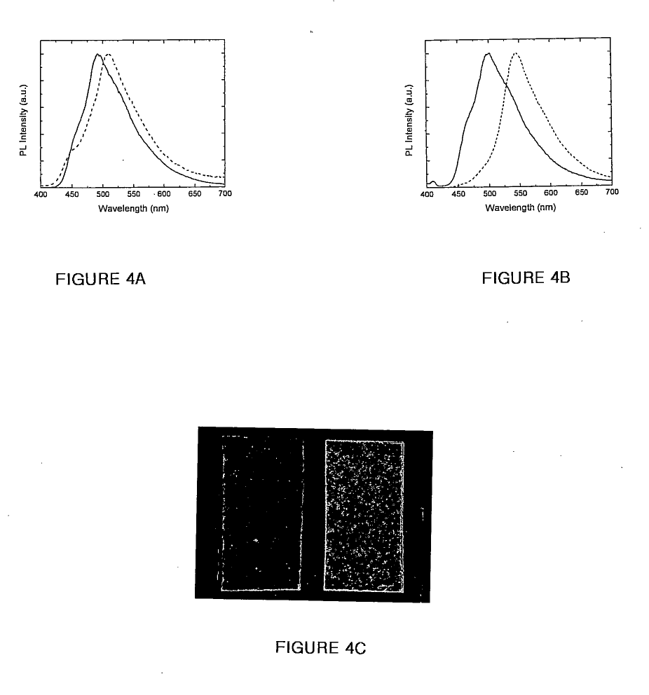

Reference photoluminescent dye C1-YB (FIG. 2) was synthesized according to literature procedures (Lowe, C.; Weder, C. Synthesis 2002, 9, 1185). Reference blends and objects comprising between 0.01 and 10% of the reference photoluminescent dye C1-YB and one of the polymers poly(methyl methacrylate) (PMMA), and bisphenol-A polycarbonate (PC) were prepared by feeding the appropriate amounts of dye and the polymer into a recycling, co-rotating twin-screw mini-extruder (DACA Instruments, Santa Barbara, Calif.), mixing for 3-5 minutes at about 200-220° C. (PMMA) and 230-250° C. (PC), and subsequent extrusion. PC/C1-YB blends comprising 5 or 10% w/w of the dye were also prepared by manually mixing the compounds for 10 minutes in an aluminum dish on a hot stage at ca. 230° C. Films were prepared by compression-molding the blends at the same temperature at which they were extruded between two aluminum foils that were optionally covered with covered with Kapton films in a Carver press using spacers for approximately 1-3 minutes. The films were immediately quenched after removal from the hot press by immersion in an ice-water bath. The resulting blend films had a homogeneous thickness of between about 100-200 μm, depending on the spacer used. Thinner films were prepared in an analogue manner between two glass slides. All freshly prepared films of this experiment displayed PL emission spectra (FIGS. 4A and 4B) that are characteristic of monomer emission, that is, emission from well-dispersed chromophore molecules in the polymer matrix. Heating the films comprising 2% w/w or less of the chromophores for extended periods of time (1-30 hours) to temperatures of about 20-40° above their Tg, which was determined by differential scanning calorimetry, did not lead to any significant changes of the materials PL spectra, the visual impression of their PL characteristic under excitation, or a visually detectable change of their absorption color. This experiment shows that high solubility of the prior art PL dyes in a matrix polymer can prevent dye aggregation. In turn, heating the films comprising 5% w/w or more of the chromophores for extended periods of time (1-30 hours) to temperatures of about 20-40° above their T_{g}, which was determined by differential scanning calorimetry, did lead to changes of the materials PL spectra (FIGS. 4A and 4B) and the visual impression of their PL characteristic under excitation with UV light changed from blue to green (FIG. 4C). However, no visually detectable change of the absorption color of these films was observed. This experiment shows that high solubility of the prior art PL dyes in a matrix polymer requires high concentrations of the PL dye to achieve dye aggregation. Internal absorption effects, which have been described in the prior art that is included herein by reference (Crenshaw, B.; Weder, C.; Thermally Induced Color Changes in Melt-Processed Photoluminescent Polymer Blends; Adv. Mater. 2005, 17, 1471-1476) lead to limitations of the changes of the materials PL spectra upon aggregation which limit the performance of the prior art PL TTI materials and devices. This experiment further shows that the prior art excimer-forming photoluminescent chromophore C1-YB which displays ground-state/excited state interactions and prior art blends thereof with PC or PMMA. (Crenshaw, B.; Weder, C.; Thermally Induced Color Changes in Melt-Processed Photoluminescent Polymer Blends; Adv. Mater. 2005, 17, 1471-1476) is not useful for embodiments of the present invention.

### EXAMPLE B

Aggregachromic dye C1-RG (FIG. 1A) was synthesized according to literature procedures (Lowe, C.; Weder, C. Synthesis 2002, 9, 1185). Aggregachromic dyes C18-RG, C12-RG, C1-RG, and C2-RY8 (FIGS. 1A and 1B) were synthesized as follows: Synthesis of (4-dodecyloxyphenyl)acetonitrile. A suspension of K₂CO₃ (4.05 g, 29.2 mmol) in dimethylformamide (15 mL) was purged with Ar for 15 minutes, heated to 80° C., and 4-hydroxyphenylacetonitrile (1.47 g, 11.0 mmol) was added. After stirring at 80° C. for 10 minutes, 1-bromododecane (3.54 g, 14.2 mmol) was slowly added and the suspension was stirred at 80° C. under Ar for another 4 hours. After this time a pale yellow precipitate had formed. The reaction was terminated by pouring the suspension into ice-water (150 mL) and CHCl₃ (50 mL) was added to dissolve the precipitate. The organic layer was separated off and the aqueous phase was extracted with CHCl₃ (3×50 mL). The combined organic layers were washed with H₂O and saturated aqueous NaCl. The organic phase was dried with MgSO₄, filtered, and the solvent was evaporated in vacuo to yield a pale yellow powder (3.30 g). Recrystallization from EtOH (50 mL) afforded (4-dodecyloxyphenyl)acetonitrile in the form of white crystals (2.56 g, 77%). ¹H NMR: δ=7.23 Hz (d, 2 H, ArH), 6.89 Hz (d, 2 H, ArH), 3.95 Hz (t, 2 H, CH₂—O), 3.69 Hz (s, 2 H, CH₂—CN), 1.7-1.9 Hz (m, 2 H, CH₂), 1.5-1.2 Hz (m, 18 H, 9×CH₂), 0.89 Hz (t, 3 H, CH₃).

Synthesis of 1,4-bis-(α-cyano-4-dodecyloxystyryl)-2,5-dimethoxybenzene (C12-RG). 2,5-Dimethoxyterephthaldehyde (146 mg, 0.75 mmol) and (4-dodecyloxy-phenyl)acetonitrile (500 mg, 1.66 mmol) were dissolved at 70° C. in a mixture of t-BuOH (11 mL) and THF (5 mL). t-BuOK (0.11 mL of a 1 M solution in THF, 0.11 mmol) and n-BU₄NOH (1 mL of a 1 M solution in MeOH, 1 mmol) were added quickly and an orange precipitate started to form immediately. The mixture was stirred for 15 minutes at 70° C., cooled to RT, and poured into acidified methanol (50 mL containing 1 drop of conc. acetic acid). The resulting precipitate was filtered off, excessively washed with MeOH, and dried in vacuo at 50° C. to yield C12-RG (515 mg, 90%) in the form of orange crystals. DSC: K 93° C. (2.64 J/g), LC 112° C. (3.38 J/g), I 166° C. (52.4 J/g) ¹H NMR: δ=7.90 Hz (2×s, 2×2 H, ArH+CH═CCN), 7.67 Hz (d, 4 H, ArH), 6.99 Hz (d, 4 H, ArH), 4.02 Hz (t, 4 H, O—CH₂), 3.97 Hz (s, 6 H, O—CH₃), 1.8 Hz (m, 4 H, CH2), 1.6-1.2 Hz (m, 36 H, 9×CH₂), 0.90 Hz (t, 6 H, CH₃). Anal. Calcd for C₅₀H₆₈O₄N₂: C, 78.91; H, 9.01; N, 3.68; O, 8.41. Found: C, 78.16; H, 9.15; N, 3.61; O, 9.09.

Synthesis of (4-octadecyloxyphenyl)acetonitrile. A suspension of K₂CO₃ (4.05 g, 29.2 mmol) and dimethylformamide (15 mL) was purged with Ar for 15 minutes and heated to 80° C., and 4-hydroxyphenylacetonitrile (1.47 g, 11.0 mmol) was added. After 10 minutes, 2-bromooctadecane (4.03 g, 12.1 mmol), which had been liquefied by warming to 30° C. in a water bath, was slowly added via a syringe, and the suspension was stirred at 100° C. under Ar for another 4 hours. After this time, a pale yellow precipitate had formed. The reaction was terminated by pouring the suspension into ice-water (150 mL) and CHCl₃ (50 mL) was added to dissolve the precipitate. The organic layer was separated off and the aqueous phase was extracted with CHCl₃ (3×50 mL). The combined organic layers were washed with H₂O and saturated aqueous NaCl. The organic phase was dried with MgSO₄, filtered, and the solvent was evaporated in vacuo to yield a pale yellow powder (4.20 g). Recrystallization from EtOH (80 mL) afforded (4-octadecyloxyphenyl)acetonitrile in the form of pale yellow crystals (3.69 g, 87%). ¹H NMR: δ=7.22 Hz (d, 2 H, ArH), 6.89 Hz (d, 2 H, ArH), 3.95 Hz (t, 2 H, CH₂—O), 3.69 Hz (s, 2 H, CH₂—CN), 1.7-1.8 Hz (m, 2 H, CH₂), 1.5-1.2 Hz (m, 30 H, 15×CH₂), 0.89 Hz (t, 3 H, CH₃).

Synthesis of 1,4-bis-(α-cyano-4-octadecyloxystyryl)-2,5-dimethoxybenzene (C18-RG). 2,5-Dimethoxyterephthaldehyde (115 mg, 0.59 mmol) and (4-octadecyloxy-phenyl)acetonitrile (500 mg, 1.30 mmol) were dissolved at 80° C. in a mixture of t-BuOH (11 mL) and THF (7 mL). t-BuOK (0.09 mL of a 1 M solution in THF, 0.09 mmol) and n-Bu₄NOH (1 mL of a 1 M solution in MeOH, 1 mmol) were added quickly and an orange precipitate started to form immediately. The mixture was stirred for 15 minutes at 80° C., cooled to RT, and poured into acidified methanol (50 mL containing 1 drop of conc. acetic acid). The resulting precipitate was filtered off, excessively washed with MeOH, and dried in vacuo at 50° C. to yield C18-RG (495 mg, 90%) in the form of orange crystals. DSC: K 117° C. (13.0 J/g), LC 142° C. (25.9 J/g), I 154° C. (48.8 J/g). ¹H NMR: δ=7.89 Hz (s, 2 H, CH═CCN), δ=7.64 Hz (s, 2 H, ArH), 6.97 Hz (d, 4 H, ArH), 4.01 (t, 4H, O—CH₂), 3.96 (s, 6 H, O—CH₃), 1.8 Hz (m, 4 H, CH2), 1.6-1.2 Hz (m, 60 H, 15 ×CH₂), 0.89 Hz (t, 6 H, CH₃). Anal. Calcd for C₆₂H₉₂O₄N₂: C, 80.12; H, 9.98; N, 3.01; O, 6.89. Found: C, 79.88; H, 10.20; N, 2.93; O, 7.10.

Synthesis of {4-[2-(4-ethoxy-phenyl)-vinyl]-phenyl}-acetonitrile. A mixture of 4-ethoxystyrene (0.926 g, 6.25 mmol), 4-bromophenylacetonitrile (1.23 g, 6.25 mmol), tri-o-tolylphosphine (0.185 g, 0.60 mmol), Pd(OAc)₂ (0.029 g, 0.13 mmol), and triethylamine (2.5 mL) was placed in a heavy-walled pressure tube. Argon was bubbled through the reaction mixture for 10 minutes, the tube was closed (Teflon bushing), and heated to 100° C. in an oil bath. After stirring for 20 hours, the reaction mixture was cooled to room temperature and poured into methanol (50 mL). The precipitate was filtered off, washed with methanol and dried in vacuum. The crude product was dissolved in dichloromethane, filtered and crystallized from dichloromethane/methanol (30:70) to yield the title product as pale orange crystals (0.785 g, 48%). ¹H NMR (CDCl₃): δ 7.47 (q, 4H, ArH), 7.27 (d, 2H, ArH), 7.69 (q, 2H, ArH), 6.90 (d, 2H, CH═CH), 4.06 (q, 2H O—CH₂), 3.76 (s, 2H, CH₂), 1.43 (t, 3H, CH₃). (C₁₈H₁₇NO): Calcd. C, 82.10; H, 6.51; N 5.32; Found C, 80.94; H, 6.82; N, 5.13.

Synthesis of 3-[4-(2-cyano-2-{4-[2-(4-ethoxy-phenyl)-vinyl]-phenyl}-vinyl)-2,5-bis-octyloxy-phenyl]-2-{4-[2-(4-ethoxy-phenyl)-vinyl]-phenyl)acrylonitrile (C2-RY8). 2,5-Bis(octyloxy)terephthalaldehyde (0.250 g, 0.64 mmol) and {4-[2-(4-ethoxy-phenyl)-vinyl]-phenyl}-acetonitrile (0.505 g, 1.28 mmol) were dissolved in a mixture of t-BuOH (45 mL) and THF (20 mL) and the mixture was heated to 65° C. t-Bu-OK (0.06 mL of a 1 M solution in THF, 0.06 mmol) and n-Bu₄NOH (1.3 mL of a 1 M solution in MeOH, 1.3 mmol) were added quickly, and a red precipitate started to form immediately. The mixture was stirred for 15 minutes at 65° C., cooled to RT, and poured into acidified methanol (100 mL containing 10 drops of glacial acetic acid). The precipitate was filtered off, excessively washed with MeOH, and dried in vacuo at 50° C. Recrystallization from CHCl₃ afforded the title product in the form of red-orange crystals (451 mg, 80%). ¹H NMR (CDCl₃): δ 8.05 (s, 2H, CH═CCN), 7.92 (s, 2H, ArH), 7.68 (d, 4H, ArH), 7.55 (d, 4H, ArH), 7.46 (d, 4H, ArH), 7.05 (q, 4H, ArH), 6.90 (d, 4H, CH═CH), 4.12 (t, 4H, O—CH₂), 4.06 (q, 4H, O—CH₂), 1.85 (m, 4H, CH₂), 1.30-1.51 (m, 26H, CH₂, CH₃), 0.85 (t, 6H, CH₃). (C₆₀H₆₈N₂O₄): Calcd. C, 81.78; H, 7.78; N, 3.18; Found C, 80.52; H, 8.03; N, 3.06.

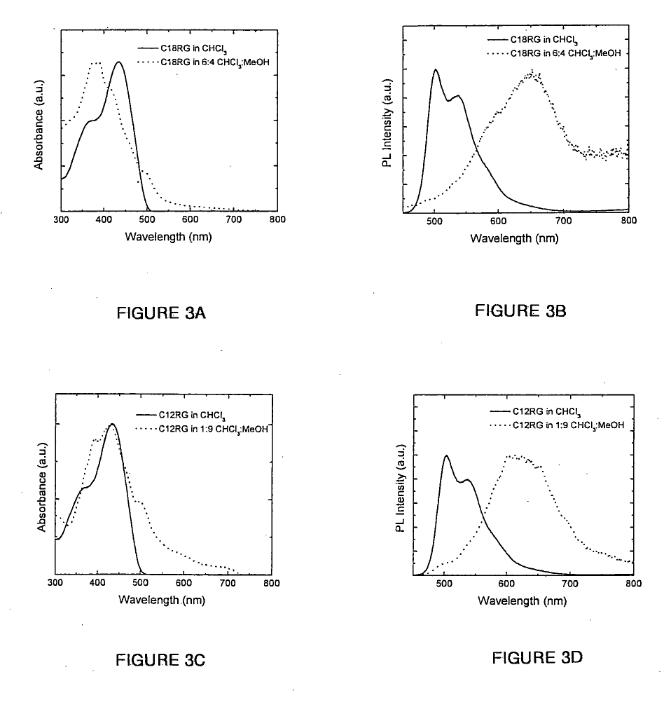

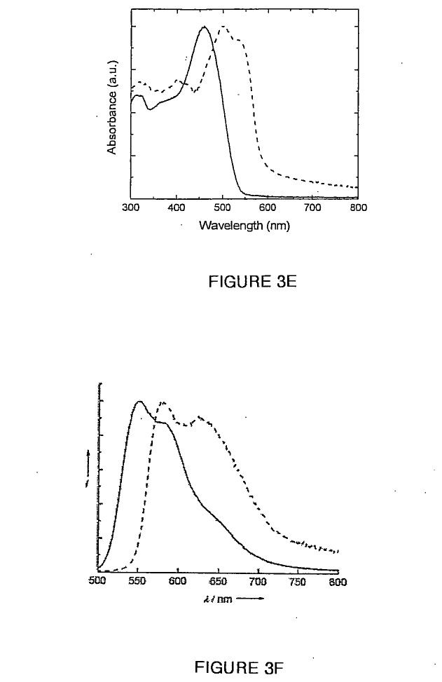

Solutions of a concentration of approximately 0.01 mmol/L C18-RG, C12-RG, or C2-RY8 in CHCl₃ (which is a good solvent for these dyes) were each prepared and the optical absorption spectra of these solutions were recorded with a Perkin Elmer (Perkin Elmer Lambda 800) UV-Vis spectrophotometer (FIGS. 3A, 3B and 3E). The PL emission spectra of these solutions were recorded with a SPEX Fluorolog FL3-12 and steady-state photoluminescence spectrometer under excitation at 435 nm (RG dyes). The experiment was repeated, but a 1:9 CHCl₃:methanol mixture (which is a poor solvent for these dyes) was used (FIGS. 3B, 3D, and 3F). The PL emission spectra of all three dyes in the 1:9 CHCl₃:methanol mixture are dominated by excimer emission, while showing predominantly monomer emission in CHCl₃, demonstrating the presence of dye aggregates and molecularly dispersed dye molecules in the two reference solvent systems. At the same time, the optical absorption spectra of these dyes (FIGS. 3A, 3C and 3E) are significantly different in CHCl₃ and a 1:9 CHCl₃:methanol mixture, indicating the presence of ground-state interactions upon aggregation, which are a characteristic of the aggregachromic dyes useful for embodiments of the present invention. This experiment shows that certain phenylenevinylenes including C18-RG, C12-RG, and C2-RY8 show the presence of ground-state interactions upon aggregation, which are a characteristic of the aggregachromic dyes useful for embodiments of the present invention. The experiment further shows that certain chromophores, such as certain phenylenevinylenes including C18-RG, C12-RG, and C2-RY8, which display properties that may make them useful as aggregachromic dyes according to the present invention may also display ground-state/excited state interactions, which can lead to excimer formation and make the aggregachromic dyes according to the present invention useful for photoluminescent time-temperature indicators similar to those disclosed in the prior art (Crenshaw, B.; Weder, C.; Thermally Induced Color Changes in Melt-Processed Photoluminescent Polymer Blends; Adv. Mater. 2005, 17, 1471-1476).

### EXAMPLE 1

### According to Invention

Materials and articles comprising between 0.2 and 5% of one of the aggregachromic dyes C18-RG, C12-RG, C2-RY8 or between 2 and 5% C1-RG and one of the polymers of poly(methyl methacrylate) (PMMA), poly(butyl/methyl methacrylate) copolymers, poly(ethylene terephthalate) (PET), and poly(ethylene terephthalate glycol) (PETG) were prepared by feeding the appropriate amounts of dye and the polymer into a recycling, co-rotating twin-screw mini-extruder (DACA Instruments, Santa Barbara, Calif.), mixing for 3-5 minutes at about 200-220° C. (PMMA, poly(butyl/methyl methacrylate) copolymers), 230-250° C. (PETG) and 280° C. (PET, PETG), and subsequent extrusion. Films were prepared by compression-molding the blends at the same temperature at which they were extruded between two aluminum foils that were optionally covered with covered with Kapton films in a Carver press using spacers for approximately 1-3 minutes. The films were immediately quenched after removal from the hot press by immersion in an ice-water bath. The resulting blend films had a homogeneous thickness of between about 100-200 μm, depending on the spacer used. Thinner films were prepared in an analogue manner between two glass slides. All freshly prepared films of this experiment displayed absorption characteristics that are characteristic of well-dispersed aggregachromic dye molecules in the polymer matrix. Visual inspection by the unassisted eye revealed that all freshly quenched films comprising C18-RG, C12-RG or between 2 and 5% C1-RG were yellow under ambient illumination and freshly quenched films comprising C2-RY8 were pale orange under ambient illumination. Visual inspection by the unassisted eye revealed that at least over the course of several months, these films did not change their appearance and did not display a color change, if kept at room temperature, that is, below their respective glass transition temperature. Heating the films comprising 0.9% w/w or more of C18-RG or C12-RG or films comprising 2% w/w or more of C1-RG to temperatures equal to or above their Tg, which was determined by differential scanning calorimetry, lead to color changes that could be readily discerned by the unassisted eye. Eventually, all films comprising these dyes adopted an orange color upon time/temperature exposure, indicating aggregation of the aggregachromic dyes in the carrier material at temperatures at or above the glass transition temperature. Heating the films comprising 0.9% w/w or more of C2-RY8 to temperatures equal to or above their T_{g}, which was determined by differential scanning calorimetry, lead to color changes that could be readily discerned by the unassisted eye. Eventually, all films comprising these dyes adopted a red color upon time/temperature exposure, indicating aggregation of the aggregachromic dyes in the carrier material at temperatures at or above the glass transition temperature. This example shows that the combined effects of time and temperature cause an irreversible color change in TTI materials and devices according to the present invention, which comprise at least one fully, or partially amorphous or semicrystalline carrier material and at least one aggregachromic dye. The example further shows that the claimed method for producing an article according to the present invention indeed yields preferred embodiments of the present invention. The example further demonstrates that in preferred embodiments of the present invention the attachment of, for example, long aliphatic substituents such as C8, C12 or C18 alkyl or alkyloxy chains can greatly reduce the solubility of possibly useful aggregachromic dyes in carrier polymers according to the present invention.

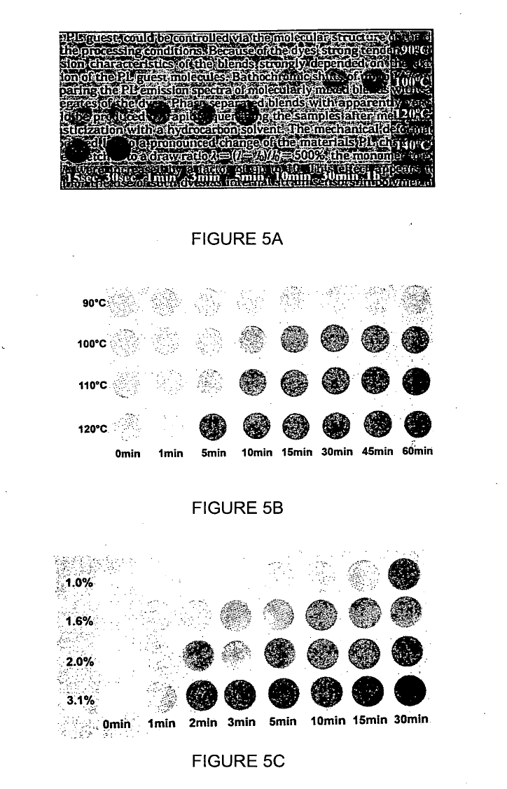

Freshly prepared blend films comprising 0.9% w/w C18-RG and poly(ethylene terephthalate) (PET) were prepared as described above and the initially yellow films were exposed to different temperatures between 90 and 140° C. and visually inspected after different times of exposure, ranging from 15 seconds to 1 hour (FIG. 5A). Films heated to 140° C. had changed their color to orange after 15 seconds and displayed no further color changes upon further heating. Films heated to 120° C. had changed their color to orange after 1 minute and displayed no further color changes upon further heating. Films heated to 100° C. were still yellow after 1 minute and displayed only a slight color change towards orange after 3 minutes; in these films the color changed further toward orange until about 30 minutes, after which no further color changes occurred. Films heated to 90° C. were still yellow after 10 minutes and displayed only a slight color change towards orange after 1 hour. A sample that was heated to 100° C. for 10 minutes, rapidly cooled to room temperature, stored at room temperature for a while, and subsequently heated to 100° C. for another 20 minutes and displayed the same color as films that were heated to 100° C. for 30 minutes. Films that were stored at 60° C., that is just below the glass transition temperature of the PET/aggregachromic dye blend determined by DSC (78° C.), for 2 days did not display any color change. This example shows that that the combined effects of time and temperature can cause an irreversible color change in materials according to the present invention, which comprise at least one fully or partially amorphous or semicrystalline carrier material and at least one aggregachromic dye. The example shows that the rate of color change is exceedingly small below a threshold temperature or threshold temperature range that correlates with the glass transition temperature of the material comprising the carrier material and aggregachromic dye according to the present invention. The example further shows that the rate of color change increases above a threshold temperature or threshold temperature range that correlates with the glass transition temperature of the material comprising the carrier material and aggregachromic dye according to the present invention and that it further increases by increasing the temperature further. The example further shows that preferred embodiments of the present invention can show a response in form of a color change that reflects the cumulative time/temperature exposure. The example further demonstrates that preferred embodiments of the present invention allow measuring the color change by visual inspection. In comparison with the phase behavior exhibited by blends of the prior art dyes C1-YB, this example also shows that the attachment of, for example, long aliphatic substituents such as C12 or C18 alkyl chains can greatly reduce the solubility of possibly useful aggregachromic dyes in carrier polymers according to the present invention. The example was repeated with blend films comprising 1.1% w/w C18-RG and poly(ethylene terephthalate glycol) (PETG) and the initially yellow films were exposed to different temperatures between 90 and 120° C. and visually inspected after different times of exposure, ranging from 0 min to 60 min (FIG. 5B). Films heated to 120° C. were still yellow after 1 minute, but had turned orange after 5 minutes. Films heated to 100° C. were still yellow after 5 minutes and displayed only a slight color change towards orange after 10 minutes; in these films the color changed further toward orange until about 45 minutes, after which no further color changes occurred. Films heated to 90° C. were still yellow after 30 minutes and displayed only a slight color change towards orange after 1 hour. This comparative example shows that the aggregation speed can be controlled via the nature of the host polymer; the 1.1% w/w C18-RG/PETG blend aggregates notably slower than the 0.9% w/w C18-RG/PET blend at the same temperature. The example was repeated with blend films comprising between 1 and 3.1% w/w C18-RG and poly(ethylene terephthalate glycol) (PETG) and the initially yellow films were exposed to a temperature of 100° C. and visually inspected after different times of exposure, ranging from 0 min to 30 minutes (FIG. 5C). Films comprising 1% w/w of the dye were still yellow after 1 minute and had turned only slightly orange after 10 minutes. Films comprising 1.6% w/w of the dye started to turn orange after 3-5 minutes. Films comprising 3.1% w/w of the dye started to turn orange after 1-2 minutes and were much more orange after 30 minutes than samples comprising only 1, 1.6, or 2% of the dye. This comparative example shows that the aggregation speed can be controlled via the concentration of the dye; the 3.1% w/w C18-RG/PETG blend aggregates notably faster than the 1% w/w C18-RG/PET blend at the same temperature.

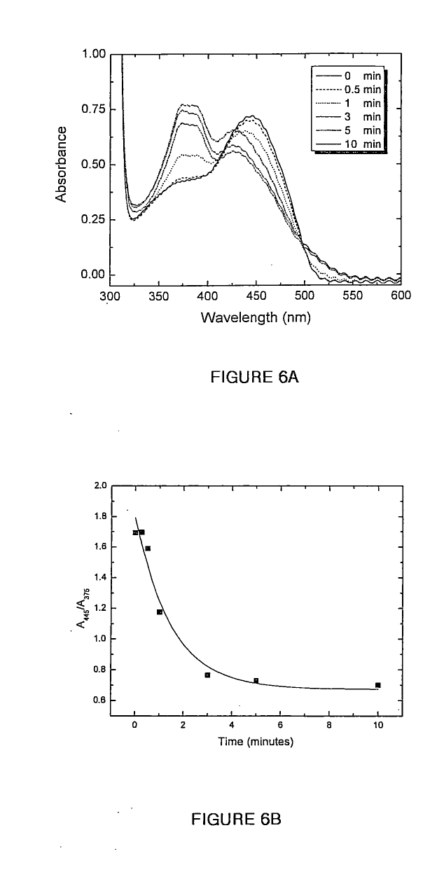

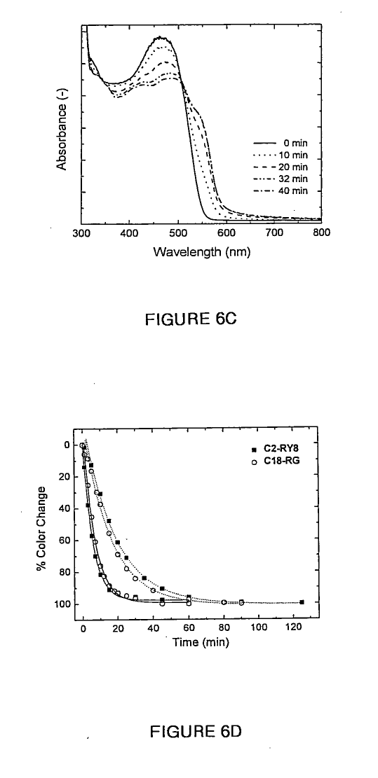

Freshly prepared blend films comprising 0.9% w/w C18-RG and poly(ethylene terephthalate) (PET) were prepared as described above and the initially yellow films were exposed to a temperature of 100° C. and the color change was measured by comparison of the optical absorption spectra of the annealed sample with an initially quenched blend film of PET and 0.9% w/w C18-RG (FIG. 6A). The quenched film shows an absorption band with a maximum at about 445 nm and a shoulder around 380 nm. This spectrum shows similar features as the one of a molecular solution of the same aggregachromic dye in CHCl₃, and is indicative of the presence of a molecular mixture or dispersion. Upon annealing, the relative intensity of the band at about 445 nm is reduced and the transition experiences a hypsochromic shift to about 425 nm. At the same time new intense absorption bands with maxima at 375 and 390 nm and a weak band in the red regime (up to ca. 550 nm) develop. These changes are indicative of the formation of ground-state aggregates, as a result of phase separation upon time/temperature exposure. The low-energy shoulder is characteristic of the formation of an intermolecular charge-transfer complex, while the transformation of the main absorption band seems to suggest out-of-plane twisting of the chromophores around their long axis upon aggregation. The example shows that preferred embodiments of the present invention can show a color change that is caused by aggregation of initially well-dispersed or dissolved aggregachromic dye molecules. The example further demonstrates that preferred embodiments of the present invention allow measuring the color change by means of optical absorption spectra. The example further demonstrates that preferred embodiments of the present invention display significant color changes characterized by significant changes of the optical absorption spectrum in the wavelength regime between 300 and 700 nm which include increase or decrease of absorbance at a given wavelength, shift of the maximum of an absorption band, appearance of a new absorption band, and disappearance (manifested in the reduction of the intensity) of a previously existing absorption band. The example was repeated with freshly prepared blend films comprising 2% w/w C2-RY8 and poly(ethylene terephthalate glycol) (PETG) and the initially slightly orange films were exposed to a temperature of 100° C. and the color change was measured by comparison of the optical absorption spectra of the annealed sample with the original spectrum (FIG. 6C). The quenched film shows an absorption band with a maximum at about 463 nm. This spectrum shows similar features as the one of a molecular solution of the same aggregachromic dye in CHCl₃, and is indicative of the presence of a molecular mixture or dispersion. Upon annealing, the relative intensity of the band at about 463 nm is reduced and the transition experiences a bathochromic shift to about 540 nm. These changes are indicative of the formation of ground-state aggregates, as a result of phase separation upon time/temperature exposure. The change is characteristic of the formation of an intermolecular charge-transfer complex and/or the planarization of the chromophores around their long axis upon aggregation. The example shows that preferred embodiments of the present invention can show a color change that is caused by aggregation of initially well-dispersed or dissolved aggregachromic dye molecules. The example further demonstrates that preferred embodiments of the present invention allow measuring the color change by means of optical absorption spectra. The example further demonstrates that preferred embodiments of the present invention display significant color changes characterized by significant changes of the optical absorption spectrum in the wavelength regime between 300 and 700 nm which include increase or decrease of absorbance at a given wavelength, shift of the maximum of an absorption band, appearance of a new absorption band, and disappearance (manifested in the reduction of the intensity) of a previously existing absorption band.

To further explore the response function and time/temperature behavior of preferred embodiments of the present invention, the influence of the time/temperature exposure on the color change can be investigated in greater detail by means of a more detailed analysis of the above-described absorption spectra (FIG. 6A) collected upon exposing films comprising 0.9% w/w C18-RG and poly(ethylene terephthalate) (PET) to a temperature of 100° C. For example, the ratios of the absorbances at 445 nm and 375 nm (A₄₄₅/A₃₇₅), which reflect contributions of well dispersed and aggregated aggregachromic dye molecules, respectively, can be plotted as a function of annealing time (FIG. 6B) and it can be seen that the data are well described by a single exponential function, from which a time constant T (˜1.5) can be extracted that allows for a predictive description of the rate of the color change displayed by preferred embodiments of the present invention at a given temperature. The Johnson-Mehl-Avrami-Kolmogorov transformation kinetics, well known in the prior art (Avrami, M. A. J. Phys. Chem. 1939, 7, 1103. Avrami, M. A J. Phys. Chem. 1940, 8, 212. c) Avrami, M. A J. Phys. Chem. 1941, 9, 177. Johnson, W. A.; Mehl, R. F. Trans. Am. Inst. Mining. Met. Engrs. 1939, 135, 416. Ruitenberg, F.; Woldt, E.; Pefford-Long, A. K. Thermochim. Acta 2001, 378, 97), teaches that for a given temperature the characteristic time constant T can decrease with dye concentration. Further, widely used phenomenological descriptions for the viscoelastic behavior of materials above T_{g}, (Ferry, J.D.; Viscoelastic Properties of Polymers; 3rd ed.; Wiley: New York, 1980) such as the Vogel-Fulcher-Tamann-Hesse equation (Vogel, H. Physik Z. 1921, 22, 645. Fulcher, G. S. J. Am. Ceram. Soc. 1925, 8, 339. Tammann, G.; Hesse, W. Z. Anorg. Allg. Chem. 1926, 156, 245), or the Williams-Landel-Ferry equation (Williams, M. L; Landel, R. F.; Ferry, J. D. J. Am. Chem. Soc. 1955, 77, 3701) allow one to express the kinetic rates at different temperatures by way of time-temperature superposition, and the prior art suggest that T scales linearly with 1/T or 1/(T−T_{g}). This experiment shows that the rate of the color change of preferred embodiments according to the present invention as a function of time/temperature exposure is very predictable. Similar experiments were conducted to compare the rate of the color change for PETG blends comprising the same amount of different dyes. FIG. 6D shows the color change extracted from absorption spectra as a function of time for initially quenched 1% w/w PETG/C18-RG blends (◯) annealed at 95° C. (dashed) and 100° C. (solid) or 1% w/w PETG/C2-RY8 blends (□) annealed at 110° C. (dashed) and 130° C. (solid). The relative intensities were determined from the ratios of the absorbances of at 445 nm and 375 nm in case of PETG/C18-RG blends and 463 and 540 in case of PETG/C2-RY8 blends. These data illustrate that the same rate of color change can be obtained by using two different dyes in the same concentration and in the same host polymer at very different temperatures. The results further demonstrate that very different rates of color change can be obtained by using two different dyes in the same concentration and in the same host polymer at the same temperature. Thus, the rate of aggregation in a given host polymer and at a given temperature can be tailored not only via the concentration of the dye, but also through design of the dye structure; specifically the example shows that longer dye molecules aggregate slower than shorter dye molecules at the same temperature.

Freshly prepared blend films comprising 0.9% w/w C18-RG and poly(ethylene terephthalate) (PET) were prepared as described above as were freshly prepared blend films comprising 0.9 w/w C18-RG and a poly(butylmethacrylate) with a T_{g} of 15° C. and the initially yellow films were exposed to a temperature of about 25° C. and the color change was measured by visual inspection. After 3 hours, the C18-RG/poly(butylmethacrylate) film had turned orange, while the C18-RG/PET film was still yellow. After another 120 hours, the C18-RG /poly(butylmethacrylate) film displayed the same orange color as after 3 hours and the C18-RG/PET film displayed the same yellow color as after 3 hours. This example shows that the response function, including but not limited to the threshold temperature range and the rate of color change under certain conditions, can be readily changed by choice of the carrier material. The example also demonstrates that it may be desirable, as claimed in preferred embodiments of the present invention, to combine more than one carrier material and more than one aggregachromic dye, for example to increase the amount of information that can be acquired with a single measurement.

Freshly prepared blend films comprising 0.9% w/w C18-RG and poly(ethylene terephthalate) (PET) were prepared as described above as were freshly prepared blend films comprising 0.9% w/w C18-RG and a PETG and the initially yellow films were pressed between glass slides at a temperature of about 120° C. and the color change was measured by visual inspection. After 1 hour, both films had turned orange. While the C18-RG/PET film had remained solid and retained its mechanical integrity, the C18-RG/PETG film had become fluid and lost its mechanical integrity and as a result changed its shape during the process. This experiment shows that a semicrystalline carrier polymer has certain advantages over a fully amorphous carrier polymer, as claimed in preferred embodiments of the present invention.

Materials and articles comprising either 1 or 2% w/w of C18-RG and a low-molecular urethane compound that was prepared by the reaction of methylene-bisphenyldiibutylcarbamate (prepared by the reaction of methylenebisphenyl-diisocyanate with two equivalents of 1-butanol) were prepared by melt-mixing the compounds at 200° C., shaping the resulting mixture, and subsequently cooling by immersion in an ice-water bath. Visual inspection of the materials (hard, brittle transparent material that crystallized upon heating to 80° C. and liquidified upon further heating to about 110° C.) indicated that this process allowed the formation of amorphous glasses. Visual inspection by the unassisted eye revealed that all freshly quenched materials were yellow under ambient illumination. After storing the articles for 24 hours at about 25° C. the films had changed their color to orange, as could be readily discerned by the unassisted eye. This example shows that the combined effects of time and temperature can cause an irreversible color change in materials according to the present invention, which comprise at least one amorphous carrier material and at least one aggregachromic dye. The example further shows that the materials can be produced that do display color changes below a characteristic transition temperature such as T_{g}. Upon heating freshly prepared articles to about 80° C., the color of the material changed within a few seconds from yellow to orange upon passing the thermal transition. This example shows that materials according to this invention can be produced that display rapid color changes upon reaching a characteristic transition temperature such as T_{g}.

### EXAMPLE 2

### According to Invention

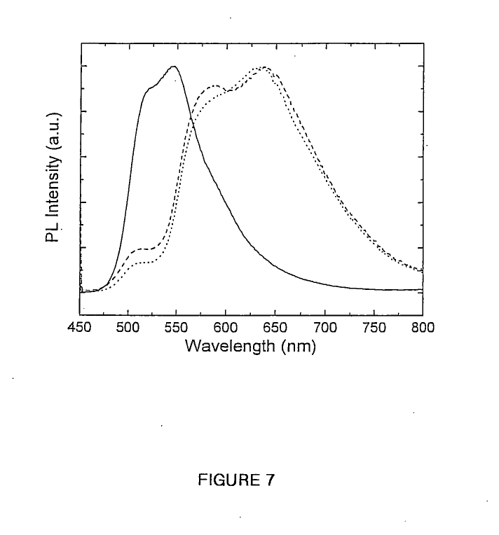

Materials and articles comprising between 0.2 and 4% of one of the aggregachromic dyes C18-RG and C12-RG and one of the polymers of poly(methyl methacrylate) (PMMA), poly(butyl/methyl methacrylate) copolymers, poly(ethylene terephthalate) (PET), and poly(ethylene terephthalate glycol) (PETG) were prepared by feeding the appropriate amounts of dye and the polymer into a recycling, co-rotating twin-screw mini-extruder (DACA Instruments, Santa Barbara, CA), mixing for 3-5 minutes at about 200-220° C. (PMMA, poly(butyl/methyl methacrylate) copolymers), 230-250° C. (PETG) and 280° C. (PET, PETG), and subsequent extrusion. Films were prepared by compression-molding the blends at the same temperature at which they were extruded between two aluminum foils that were optionally covered with covered with Kapton films in a Carver press using spacers for approximately 1-3 minutes. The films were immediately quenched after removal from the hot press by immersion in an ice-water bath. The resulting blend films had a homogeneous thickness of between about 100-200 μm, depending on the spacer used. Blend films comprising 1% w/w C2-RY8 and PET or PETG were prepared in similar fashion. Upon excitation with ultraviolet (UV) light, all freshly prepared films of this experiment comprising C18-RG or C12-RG displayed green fluorescence with an emission maximum at a wavelength of about 546 nm (FIG. 7). Their PL emission spectra displayed modest (about 10 nm) hypsochromic shifts and a redistribution of the intensity of the phonon bands when compared to those of CHCl₃ solutions of the dyes (presumably due to internal re-absorption, which arises from the overlap of the dyes' absorption band with the high-energy portion of the emission spectra but otherwise matched the latter well. Similarly, all freshly prepared films of this experiment comprising C2-RY8 displayed pale pink-orange fluorescence characteristic of monomer emission. Thus, the experiment shows that upon quenching the polymer/dye blends rapidly from the melt, the dye molecules are, at least at the concentration investigated here, incorporated in the polymer matrix in an apparently molecularly dispersed or dissolved fashion. In a series of annealing experiments all polymer/dye blends were annealed above their T_{g} in order to study whether or not the dye molecules would aggregate if given adequate translational mobility. Initial screening experiments were carried out by placing film strips for 2 hours on a hot stage that provided a spatial temperature gradient in the range of 90-150° C. Additional annealing experiments were conducted at selected temperatures of between 90 and 140° C. Gratifyingly, the color of the photoluminescence of materials comprising C18-RG or C12-RG changed to orange as could be readily be determined by visual inspection with the help of a UV lamp, upon annealing films comprising 0.5% w/w or more C18-RG, for example in PET, or films comprising 1% w/w or more C12-RG, for example in PET. These changes could also be measured by PL spectroscopy. For example, the emission spectra of a 0.5% w/w PET/C18-RG blend film displayed a weak shoulder around 640 nm upon annealing at 100° C. This change was much more pronounced in the case of 0.9% w/w C18-RG blend films that were annealed at a temperature of 90° C. or above. In this case, a dominant, unstructured red emission band centered at 637 nm developed upon annealing (FIG. 7). The red portion of the spectrum is characteristic of excimer emission and reflects phase separation and the formation of ground-state dye aggregates. Similarly, blend films comprising 1% w/w C2-RY8 in PETG rapidly changed their fluorescence color to red, upon annealing at 100° C. This experiment shows that photoluminescent articles that are embodiments of the present invention can display much larger irreversible changes of the emission spectrum at lower dye concentrations than the articles, materials and devices known in the prior art. Reason for this is the reduced solubility of the PL dyes, which lowers the minimum concentration of the PL dye required for phase separation in a matrix polymer to occur, which, for example due to lesser internal absorption, leads to larger changes of the emission spectrum.

Freshly prepared blend films comprising 0.9% w/w C18-RG and poly(ethylene terephthalate) (PET) were prepared as described above as were freshly prepared blend films comprising 0.9% w/w C18-RG and a PETG and the films were pressed between glass slides at a temperature of about 120° C. and the change of the photoluminescence color was measured by visual inspection with the help of a UV lamp. After 1 hour, the photoluminescence of both films had turned from green to orange. While the C18-RG/PET film had remained solid and retained its mechanical integrity, the C18-RG/PETG film had become fluid and lost its mechanical integrity and as a result changed its shape during the process. This experiment shows that a semicrystalline carrier polymer may have certain advantages over a fully amorphous carrier polymer, in photoluminescent articles that are embodiments of the present invention.

### EXAMPLE 3

### According to Invention

Materials and articles comprising about 2% w/w of C18-RG and a poly(butyl/methyl methacrylate) copolymer with a glass transition temperature of 52° C. were prepared as follows: about 2.5 mg C18-RG and about 123 mg of the poly(butyl/methyl methacrylate) copolymer were dissolved in 15.0 g CHCl₃ and the resulting solution was slowly added under rapid stirring to a solution of 400 mg sodium docecylsulfate in 40 g distilled water. The mixture was stirred for 1 hour, diluted with 80 g of a 1% w/w aqueous sodium chloride solution and the chloroform was (partially) evaporated at room temperature under vacuum to yield an aqueous suspension of orange, about spherical microparticles having an average diameter of ca. 10 μm. These microparticles were collected by centrifugation and 10 mg of the isolated microparticles were dispersed in 1 mL of a mixture of ethylene glycol (EG) and water. This dispersion was heated to about 150° C. upon which the color of the spheres changed from orange to yellow. The dispersion was subsequently rapidly injected into 10 ml of EG and the microparticles were collected by filtration. This yielded yellow, about spherical microparticles of an average diameter of about 10 μm. Modification of the experimental parameters of this experiment resulted in particles that could not be seen under a normal light microscope (and therefore had a size in the nm regime). Similarly, aggregates of a diameter of a few millimeters were observed under appropriate conditions. This experiment demonstrates that articles according to the present invention can readily be produced in a broad variety of shapes including, but not limited to, spherical particles with average diameters ranging from the nanometer to the millimeter regime.

Heating yellow, spherical microparticles of an average diameter of about 10 μm (prepared as described above) that were deposited from a suspension on a glass substrate to a temperature of 80° C. rapidly changed their visual appearance from yellow to orange, indicating aggregation of the aggregachromic dyes in the carrier material at a temperature that is above the glass transition temperature of the composition. This example shows that the combined effects of time and temperature cause an irreversible color change in TTI materials and devices according to the present invention, which comprise at least one fully or partially amorphous or semicrystalline carrier material and at least one aggregachromic dye, and in which the TTI material is about spherically shaped.

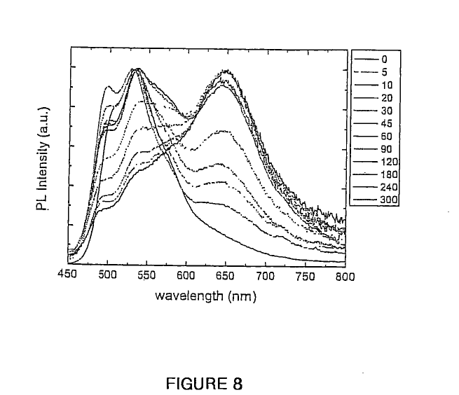

The above experiment was repeated, but the photoluminescence of the highly photoluminescent particles was investigated (FIG. 8). Upon excitation with ultraviolet (UV) light all freshly prepared particles of this experiment displayed green fluorescence with an emission maximum at a wavelength of about 546 nm (FIG. 8); their PL emission spectra are characteristic of monomer emission. Thus, the experiment shows that upon quenching the polymer/dye spheres rapidly from the melt, the dye molecules are, at least at the concentration investigated here, incorporated in an apparently molecularly dispersed or dissolved fashion. In a series of annealing experiments the 10 μm spheres of this experiment were annealed at 80° C. in order to study whether or not the aggregation of the aggregachromic dye molecules according to the present invention would also change the photoluminescent properties of the spheres. Gratifyingly, the color of the photoluminescence changed to orange as could be readily determined by visual inspection with the help of a UV lamp. These changes could also be measured by PL spectroscopy (FIG. 8). A dominant, unstructured red emission band centered at 637 nm developed upon annealing. The red portion of the spectrum is characteristic of excimer emission and reflects phase separation and the formation of ground-state dye aggregates. This experiment shows that photo-luminescent articles that are embodiments of the present invention can be of different shape than the films known in the prior art, for example the preferred shape of spheres with well-defined dimension in the nm to mm regimes.

In accordance with the patent statutes, the best mode and preferred embodiment have been set forth; the scope of the invention is not limited thereto, but rather by the scope of the attached claims.

What is claimed is:

1. A composition capable of undergoing a measurable time-temperature color change, comprising: at least one fully or partially amorphous or semicrystalline carrier material and at least one aggregachromic dye, wherein the combined effects of time and temperature are capable of causing an irreversible color change in the composition.

2. The composition according to claim 1, wherein said color change is a change of an optical absorption spectrum in the wavelength regime between 300 and 700 nm and is characterized by one or more of the following: (i) increase or decrease of absorbance at a given wavelength by more than 10%, (ii) shift of the maximum of an absorption band by more than 10 nm, (iii) appearance of a new absorption band, and (iv) disappearance of a previously existing absorption band.

3. The composition according to claim 2, wherein said increase or decrease of absorbance at a given wavelength is by more than 50%, and said shift of the maximum of an absorption band is by more than 50 nm.

4. The composition according to claim 2, wherein said color change is capable of being detected with the unassisted eye.

5. The composition according to claim 1, wherein said fully or partially amorphous or semicrystalline carrier material is a solid at least one temperature in a temperature regime in which it is being used and is a non-polymeric organic amorphous glass, glassy amorphous polymer, or semicrystalline polymer.

6. The composition according to claim 5, wherein said fully or partially amorphous or semicrystalline carrier material is poly(methylmethacrylate), poly(methacrylate), poly(butyl acrylate), poly(butyl methacrylate), poly(acrylamide), poly(acrylonitrile), poly(styrene), poly(acrylonitrile), a polyacrylate copolymer, a polyamide, a polyester, poly(ethylene terephthalate), poly(ethylene terephthalate glycol), poly(butylene terephthalate), poly(ethylene naphthalate), a poly(ethylene terephthalate) copolymer, a poly(carbonate), a polyurethane, a poly(aryl sulfone), poly(phenyleneoxide), or a polyolefin or a copolymer or combination thereof.

7. The composition according to claim 1, wherein said aggregachromic dye is present in a concentration from 0.001 parts to less than 10 parts per 100 parts by weight of the carrier material.

8. The composition according to claim 7, wherein said aggregachromic dye is present in a concentration from 0.5 parts to less than 5 parts per 100 parts by weight of the carrier material.

9. The composition according to claim 7, wherein said aggregachromic dye has the general formula: 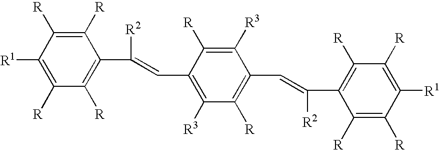
wherein R² is H, a straight chain, branched or cyclic saturated alkyl, alkenyl, or alkynyl, a hydroxy alkyl, alkyloxy, carboxy alkyl, aryl, or substituted aryl, cyano, halogen, Cl, F, Br, C(═O)R, C(═O)OR, C(═O)NR₂, CF₃, CN, S(O)₂OH, NO₂, and N⁺R₄, when each R, R¹, and R³, independently, is H, or comprises a straight chain, branched or cyclic saturated alkyl, alkenyl, alkynyl, hydroxy alkyl, alkyloxy, carboxy alkyl, aryl, or substituted aryl, with the proviso that at least one R¹ or R³, or a combination thereof comprises a linear or branched alkyl or alkyloxy group having 6 or more carbon atoms, or
wherein the aggregachromic dye is 1,4-bis-(α-cyano4-methoxystyryl)-2,5-di-methoxybenzene in an amount greater than 0.5 parts per 100 parts by weight of the carrier material.

10. The composition according to claim 7, wherein said aggregachromic dye is 1,4-bis-(α-cyano-4-octadecyloxystyryl)-2,5-dimethoxybenzene, or 1,4-bis-(α-cyano-4-dodecyloxystyryl)-2,5-dimethoxybenzene, 1,4-bis-(α-cyano4-methoxystyryl)-2,5-di-methoxybenzene, 3-[4-(2-cyano-2-{4-[2-(4-ethoxy-phenyl)-vinyl]-phenyl}-vinyl)-2,5-octyloxy-phenyl]-2-{4-[2-(4-ethoxy-phenyl)-vinyl]-phenyl}-acrylonitrile, or combinations thereof.

11. The composition according to claim 1, wherein the composition exhibits an initial optical absorption spectrum and is capable of exhibiting a second optical absorption spectrum after exposure to a temperature for a period of time greater than a temperature at the initial optical absorption spectrum.

12. The composition according to claim 10, wherein the combined effects of time and temperature are characterized by heating the material for a period of time to a temperature that is greater than the glass transition temperature of the composition.

13. An article comprising the composition of claim 1.

14. The article according to claim 13, wherein the article is a fiber, rod, film, sheet, tape, plate, microparticle, nanoparticle, or coating.

15. The composition according to claim 1, wherein the at least one aggregachromic dye is photoluminescent and present in an amount from 0.5 parts to less than 5 parts by weight per 100 parts by weight of the carrier material, wherein the dye has the ability to form excimers, and wherein the combined effects of time and temperature can cause an irreversible change of the emission spectrum of the at least one dye.

16. The composition according to claim 15, wherein the photoluminescent dye is present in an amount from 0.5 parts to less than 1 part by weight, and wherein said at least one carrier material is a non-polymeric organic amorphous glass or semicrystalline polymer.

17. The composition according to claim 15, wherein particles of the composition are substantially spherically shaped.

18. A method for producing a time-temperature indicator material, comprising the steps of:
combining at least one fully or partially amorphous or semicrystalline carrier material and at least one aggregachromic dye to produce a first mixture wherein the aggregachromic dye is substantially dispersed or dissolved in the carrier material; and
forming a body from the first mixture, wherein the body has an initial optical absorption spectrum and is capable of exhibiting a second optical absorption spectrum after exposure to a temperature for a period of time.

19. The method according to claim 18, wherein (a) the combining includes melt-mixing the at least one fully or partially amorphous or semicrystalline carrier material and the at least one aggregachromic dye at a first temperature to produce the first mixture, wherein the forming includes shaping the first mixture into the body at a second temperature, which may be higher or lower than the first temperature or the same, and cooling the body to a third temperature, wherein the body exhibits the initial optical absorption spectrum after the cooling and is capable of exhibiting the second optical absorption spectrum after exposure for a period of time to at least a fourth temperature which is the same or different than the third temperature, or (b) wherein the combining includes co-dissolving the at least one fully or partially amorphous or semicrystalline carrier material and an effective amount of the at least one aggregachromic dye in a common solvent to produce the first mixture, and wherein forming a body from the first mixture includes removing the solvent.

20. The method according to claim 19, wherein change between the initial optical absorption spectrum and the second optical absorption spectrum is in the wavelength regime between 300 and 700 nm and is characterized by one or more of the following: (i) increase or decrease of absorbance at a given wavelength by more than 10%, (ii) shift of the maximum of an absorption band by more than 10 nm, (iii) appearance of a new absorption band, and (iv) disappearance of a previously existing absorption band.

21. The method according to claim 20, wherein said increase or decrease of absorbance at a given wavelength is by more than 50%, and said shift of the maximum of an absorption band is by more than 50 nm.

22. The method according to claim 20, wherein said change is capable of being detected with the unassisted eye.

23. The method according to claim 19, wherein said fully or partially amorphous or semicrystalline carrier material is a solid at least one temperature in a temperature regime in which it is being used and is a non-polymeric organic amorphous glass, glassy amorphous polymer, or semicrystalline polymer.

24. The method according to claim 23, wherein said fully or partially amorphous or semicrystalline carrier material is poly(methyl methacrylate), poly(methacrylate), poly(butyl acrylate), poly(butyl methacrylate), poly(acrylamide), poly(acrylonitrile), poly(styrene), poly(acrylonitrile), polyacrylate copolymers, polyamides, polyesters, poly(ethylene terephthalate), poly(ethylene terephthalate glycol), poly(butylene terephthalate), poly(ethylene naphthalate), and amorphous poly(ethylene terephthalate)s and poly(ethylene terephthalate) copolymers, poly(carbonate)s, polyurethanes, poly(aryl sulfones), poly(phenyleneoxide), or polyolefins or a copolymer or combinations thereof.

25. The method according to claim 19, wherein said aggregachromic dye is present in a concentration from 0.001 parts to less than 10 parts per 100 parts by weight of the carrier material.

26. The method according to claim 25, wherein said aggregachromic dye is present in a concentration from 0.5 parts to less than 5 parts per 100 parts by weight of the carrier material.

27. The method according to claim 25, wherein said aggregachromic dye has the general formula: 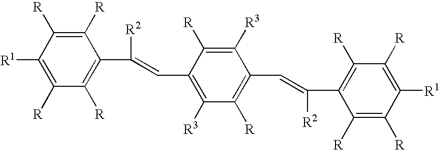
wherein R² is H, a straight chain, branched or cyclic saturated alkyl, alkenyl, or alkynyl, a hydroxy alkyl, alkyloxy, carboxy alkyl, aryl, or substituted aryl, cyano, halogen, Cl, F, Br, C(═O)R, C(═O)OR, C(═O)NR₂, CF₃, CN, S(O)₂OH, NO₂, and N⁺R₄, when each R, R¹, and R³, independently, is H, or comprises a straight chain, branched or cyclic saturated alkyl, alkenyl, alkynyl, hydroxy alkyl, alkyloxy, carboxy alkyl, aryl, or substituted aryl, with the proviso that at least one R¹ or R³, or a combination thereof, comprises a linear or branched alkyl or alkyloxy group having 6 or more carbon atoms, or
wherein the aggregachromic dye is 1,4-bis-(x-cyano-4-methoxystyryl)-2,5-di-methoxybenzene in an amount greater than 0.5 parts per 100 parts by weight of the carrier material.

28. The method according to claim 25, wherein said aggregachromic dye is 1,4-bis-(α-cyano-4-octadecyloxystyryl)-2,5-dimethoxybenzene, or 1,4-bis-(α-cyano-4-dodecyloxystyryl)-2,5-dimethoxybenzene, 1,4-bis-(α-cyano-4-methoxystyryl)-2,5-di-methoxybenzene, 3-[4-(2-cyano-2-4-[2-(4-ethoxy-phenyl)-vi nyl]-phenyl}-vinyl)-2,5-bis-octyloxy-phenyl]-2-{4-[2-(4-ethoxy-phenyl)-vinyl]-phenyl}-acrylonitrile, or combinations thereof.

29. The method according to claim 19, wherein the composition is capable of exhibiting the second optical absorption spectrum after exposure to a temperature for a period of time greater than a temperature at the initial optical absorption spectrum.

30. The method according to claim 28, wherein the second optical absorption spectrum is exhibited after heating the material for a period of time to a temperature that is greater than the glass transition temperature of the composition.

31. The method according to claim 19, wherein said first temperature and said second temperature and said third temperature and the rate of cooling said body are chosen to suppress substantial aggregation of the aggregachromic dye, or wherein said solvent is removed at a temperature and rate chosen to suppress substantial aggregation of the aggregachromic dye.

32. The method according to claim 31, wherein the fourth temperature is greater than the glass transition temperature of the first mixture, or wherein the exposure to the temperature is greater than or equal to the glass transition temperature of the first mixture.

33. The method according to claim 19, further including the step of preparing an emulsion comprising the first mixture by adding a liquid thereto that serves as a continuous phase for the emulsion and optionally an emulsifying agent, and evaporating some or all of the solvent to create the emulsion.

34. The method according to claim 33, wherein the method further includes heating the emulsion and quenching the emulsion subsequent to heating.

35. A method of determining time/temperature history of an article, comprising the steps of: (i) measuring the optical absorption spectrum of an article comprising at least one fully or partially amorphous or semicrystalline carrier material and at least one aggregachromic dye, wherein the combined effects of time and temperature cause an irreversible color change of the article and (ii) comparing said measurements of the optical absorption spectrum of the article with an initial optical absorption spectrum of the article.
